(19) United States
(12) Patent Application Publication
(10) Pub. No.: US 2026/0089671 A1
(43) Pub. Date: Mar. 26, 2026

(54) LOW-POWER POSITIONING REFERENCE SIGNAL FOR LOW-POWER RECEIVER

(71) Applicant: QUALCOMM Incorporated, San Diego, CA (US)

(72) Inventors: Chao WEI, Beijing (CN); Hao XU, Beijing (CN); Yuchul KIM, San Diego, CA (US)

(21) Appl. No.: 19/101,865

(22) PCT Filed: Oct. 7, 2022
(86) PCT No.: PCT/CN2022/123728

§ 371 Date: Feb. 6, 2025

(51) Int. Cl. H04W 64/00; H04W 52/02

(52) U.S. Cl. CPC H04W 64/00; H04W 52/0235

(57) ABSTRACT

A first or a second network node may transmit, to a first radio at a user equipment (UE), assistance data that may include a configuration of a set of low-power (LP) positioning reference signals (LP-PRSs). The UE may receive, via the first radio, the assistance data. The first network node may transmit, to a second radio at the UE, the set of LP-PRSs. The UE may receive, via the second radio, the set of LP-PRSs. The second radio may have a lower power consumption than the first radio. The first network node may transmit an LP wake-up signal (LP-WUS) including an indication to measure the set of LP-PRSs. The UE may receive, via the second radio, the LP-WUS. The UE may measure the set of LP-PRSs based on the configuration of the set of LP-PRSs and in response to receiving the LP-WUS.

### TECHNICAL FIELD

The present disclosure relates generally to communication systems, and more particularly, to wireless device systems having a low-power receiver (LPR) and/or a high-power receiver (HPR).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type e communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may receive, via a first radio, assistance data that may include a configuration of a set of low-power (LP) positioning reference signals (LP-PRSs). The apparatus may receive, via a second radio, the set of LP-PRSs. The second radio may have a lower power consumption than the first radio. The apparatus may measure the set of LP-PRSs based on the configuration of the set of LP-PRSs.

In an aspect of the disclosure, a method, a computer-readable medium, and an apparatus at a first network node are provided. The apparatus may transmit, to a second radio at a UE, a set of LP-PRSs. The apparatus may transmit, to the second radio at the UE, an LP wake-up signal (LP-WUS) including an indication to measure the set of LP-PRSs. The first network node may include a transmission reception point (TRP).

In an aspect of the disclosure, a method, a computer-readable medium, and an apparatus at a second network node are provided. The apparatus may transmit, to a first radio at a UE, assistance data that may include a configuration of a first set of LP-PRSs. The apparatus may receive, from the first radio at the UE, a measurement report based on the set of LP-PRSs. The second network node may include a location management function (LMF).

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5A is a diagram illustrating an example of a plurality of transmission reception points (TRPs) and a UE having a plurality of radios in an access network, in accordance with various aspects of the present disclosure.

FIG. 5B is a diagram illustrating the example of FIG. 5A, where a radio of the UE is been switched to an active mode, in accordance with various aspects of the present disclosure.

FIG. 6 is a diagram illustrating an example of low-power (LP) reference signal (LP-RS) based on an on-off keying (OOK) waveform.

FIG. 7 is a communication flow diagram of a UE, serving network node, neighbor network node, and location management function (LMF) in an access network, in accordance with various aspects of the present disclosure.

FIG. 7 is a communication flow diagram of a UE, serving network node, neighbor network node, and LMF in an access network, in accordance with various aspects of the present disclosure.

FIG. 8 is a communication flow diagram of a UE, serving network node, neighbor network node, and LMF in an access network, in accordance with various aspects of the present disclosure.

FIG. 9A is a diagram illustrating an example of an LP-RS having a normal signal bandwidth, in accordance with various aspects of the present disclosure.

FIG. 9B is a diagram illustrating an example of an LP-RS having a reduced, continuous signal bandwidth, in accordance with various aspects of the present disclosure.

FIG. 9C is a diagram illustrating an example of an LP-RS having a reduced, non-continuous signal bandwidth, in accordance with various aspects of the present disclosure.

FIG. 10A is a diagram illustrating an example of a repetition pattern for an LP positioning reference signal (PRS), in accordance with various aspects of the present disclosure.

FIG. 10B is a diagram illustrating an example of another repetition pattern for an LP-PRS, in accordance with various aspects of the present disclosure.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a diagram illustrating an example of a hardware implementation for an example apparatus and/or network entity.

FIG. 19 is a diagram illustrating an example of a hardware implementation for an example network entity.

FIG. 20 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

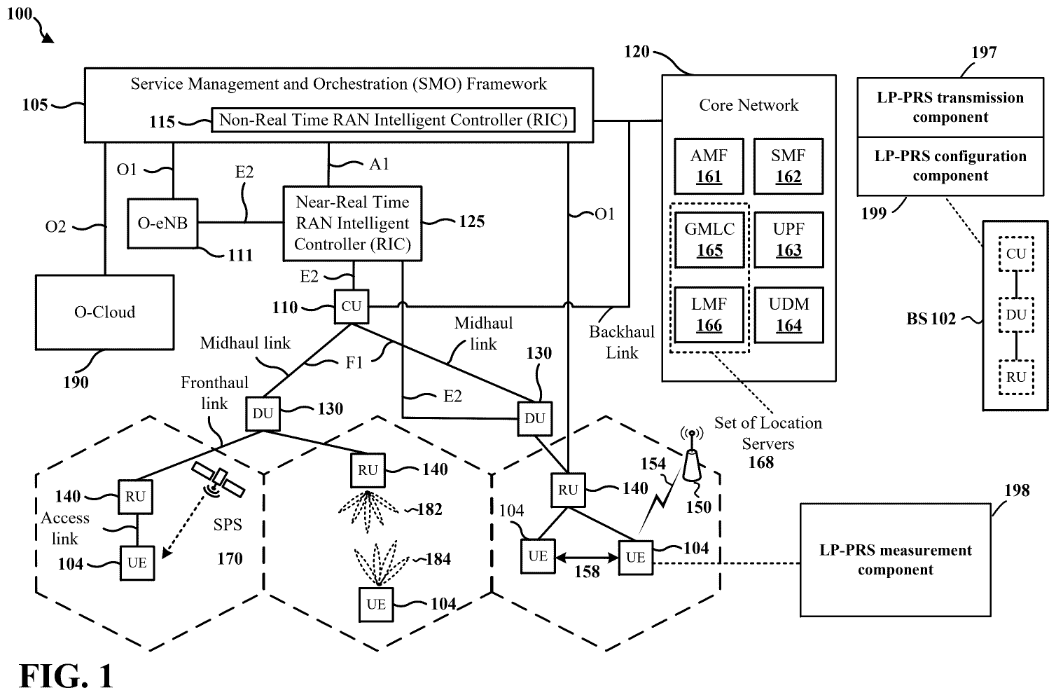

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and a velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an LP-PRS measurement component 198 configured to receive, via a first radio, assistance data that may include a configuration of a set of LP-PRSs. The LP-PRS measurement component 198 may receive, via a second radio, the set of LP-PRSs. The second radio may have a lower power consumption than the first radio. The LP-PRS measurement component 198 may measure the set of LP-PRSs based on the configuration of the set of LP-PRSs. In certain aspects, the base station 102 may have an LP-PRS transmission component 197 configured to transmit, to a second radio at a UE, a set of LP-PRSs. The LP-PRS transmission component 197 may transmit, to the second radio at the UE, an LP-WUS that may include an indication to measure the set of LP-PRSs. The second radio may have a lower power consumption than a first radio at the UE. In certain aspects, the base station 102 may have an LP-PRS configuration component 199 configured to transmit, to a first radio at a UE, assistance data that may include a configuration of a first set of LP-PRSs. The LP-PRS configuration component 199 may receive, from the first radio at the UE, a measurement report based on the set of LP-PRSs from the UE. The first radio may include a main radio (MR) and the second radio may include an LP wake-up receiver (LP-WUR). Although the following description may be focused on positioning using a wireless device with an LP-WUR and a main radio (MR), the concepts described herein may be applicable to positioning using any two receivers of a wireless device, where one receiver may have less power or functionality than the other receiver. Although the following description may be focused on 5G NR, the concepts described herein may be applicable to other similar areas, such as LTE, LTE-A, CDMA, GSM, and other wireless technologies.

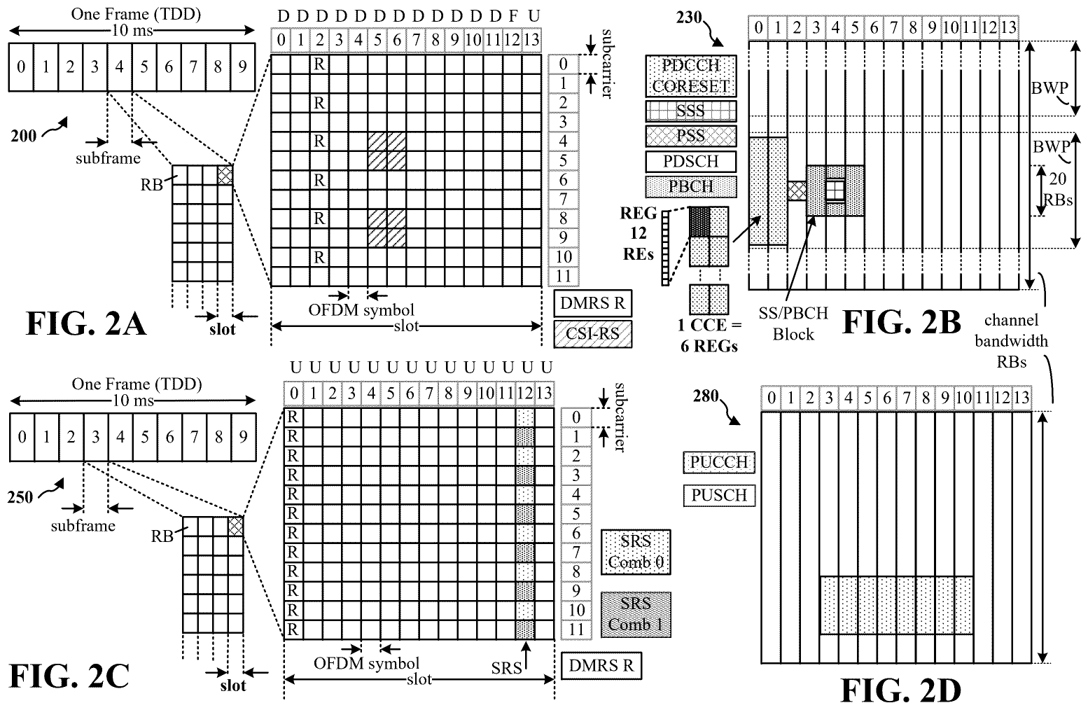

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

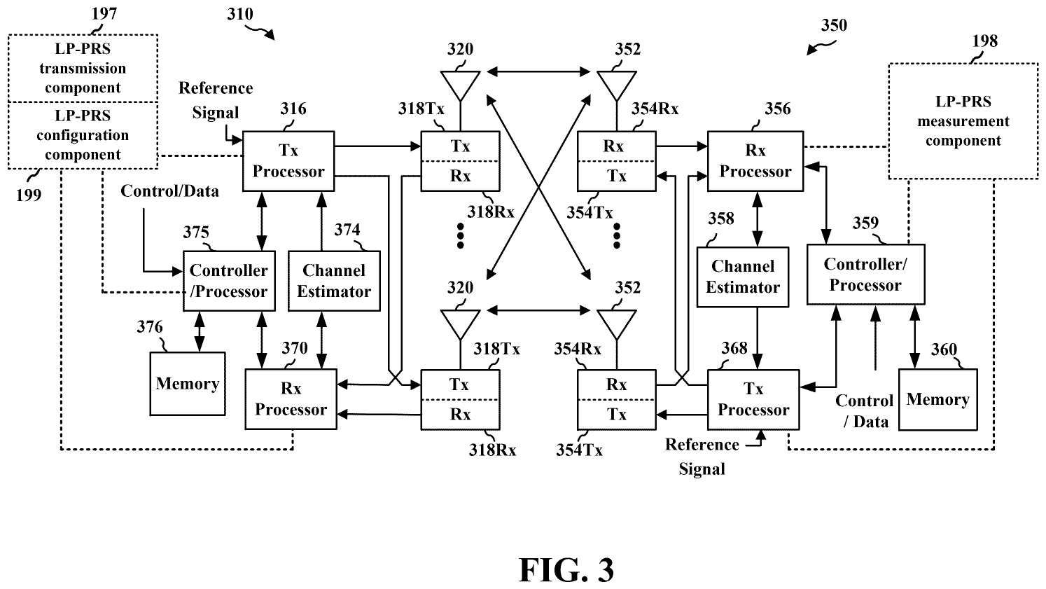

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the LP-PRS measurement component 198 of FIG. 1.

At least one of the Tx processor 316, the Rx processor 370, and the controller/processor 375 may be configured to perform aspects in connection with the LP-PRS transmission component 197 of FIG. 1.

At least one of the Tx processor 316, the Rx processor 370, and the controller/processor 375 may be configured to perform aspects in connection with the LP-PRS configuration component 199 of FIG. 1.

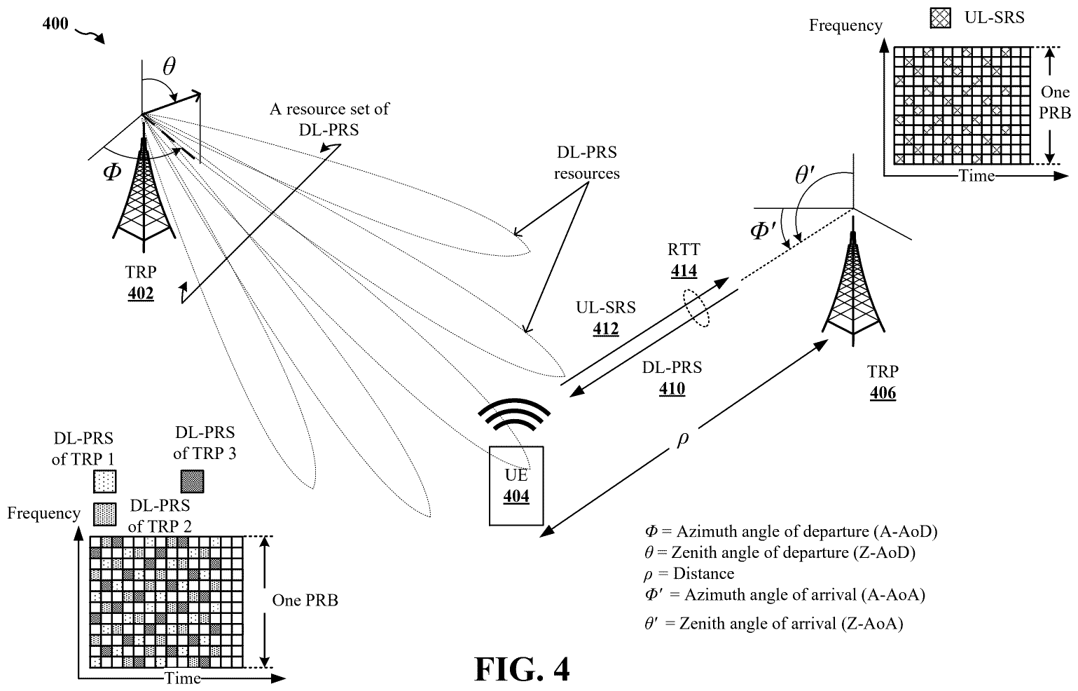

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and DL-PRS-RSRP of the received signals) using assistance data received from the positioning server, and the TRPs 402, 406 measure the gNB Rx-Tx time difference measurements (and UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and DL-PRS-RSRP) of downlink signals received from multiple TRPs 402, 406 at the UE 404. The UE 404 measures the DL RSTD (and DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and UL-SRS-RSRP) at multiple TRPs 402, 406 of uplink signals transmitted from UE 404. The TRPs 402, 406 measure the UL-RTOA (and UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, determine and/or to enhance certainty, to supplement/complement measurements, and/or to substitute/provide for missing information.

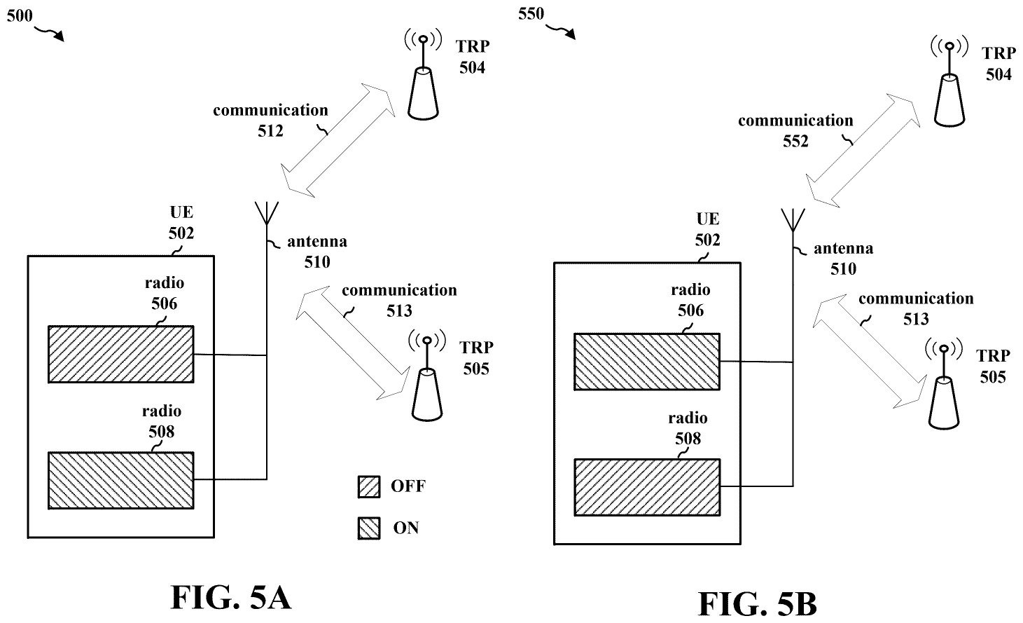

FIG. 5A is a diagram 500 illustrating a UE 502 in wireless communication with a TRP 504 and a TRP 505. The UE 502 has a radio 506 that is in an OFF mode, or a sleep mode (i.e., a deep sleep mode), and a radio 508 that is in an ON mode, or an active mode. The radio 506 may be, for example a main radio (MR) of the UE 502. The radio 508 may be, for example, a low-power (LP) wake-up radio (LP-WUR) of the UE 502. The radio 508 may be a companion receiver that monitors for an LP wake-up signal (LP-WUS). The radio 508 may have a lower power consumption than the radio 506. If the UE 502 is not scheduled to transmit or receive data in a time period, the UE 502 may be configured to switch the radio 506 to an OFF mode, or a sleep mode, during that time period. In other words, the UE 502 may be configured to switch the radio 506 to a sleep mode unless there is something to transmit. The radio 508 may be in an active mode, which monitors for receipt of a signal, such as a LP-WUS. The radio 506 and the radio 508 may share an antenna 510 to communicate with one or more network nodes, such as the TRP 504 via communication 512 or the TRP 505 via communication 513. The UE 502 may be configured to monitor for communication 512 from the TRP 504 or the communication 513 from the TRP 505 for a signal, such as an LP-WUS. In some aspects, the radio 506 and the radio 508 may use separate antennas to communicate with one or more network nodes. While the UE 502 is shown as having two radios, a UE may have more than two radios in other aspects, for example three radios, four radios, or more, with similar power consumption levels, or with different power consumption levels. The radio 506 may also be referred to as a high-power radio (HPR). The radio 508 may be referred to as a low-power radio (LPR). The radio 506 may be configured to receive and measure orthogonal frequency division multiplexing (OFDM) waveforms. The radio 508 may be configured to receive and measure on-off keying (OOK) waveforms or amplitude-shift keying-based modulated waveforms. The radio 508 may not be configured to receive and measure OFDM waveforms.

FIG. 5B is a diagram 550 illustrating the UE 502 of FIG. 5B with the radio 506 switched to an ON, or active mode and the radio 508 switched to an OFF, or inactive mode, or a sleep mode. If the UE 502 is scheduled to transmit or receive data during a time period, the UE 502 may be configured to switch the radio 506 to an ON mode, or an active mode, during that time period. In other words, the UE 502 may be configured to switch the radio 506 to an active mode when there is something to transmit. In some aspects, the TRP 504 may transmit a communication 512 to the radio 508 of the UE 502, which includes an on-demand LP-WUS. In some aspects, the TRP 505 may transmit a communication 513 to the radio 508 of the UE 502, which includes an on-demand LP-WUS. In response, the UE 502 may switch the radio 506 from the inactive mode in FIG. 5A to the active mode in FIG. 5B. When the radio 506 is in active mode, the UE 502 may transmit and receive data with the TRP 504 via the radio 506 using communication 552, or may transmit and receive data with the TRP 505 via the radio 506 using communication 513.

Use of a low power radio, such as the radio 508, may reduce total power consumption and latency at the UE 502 by minimizing the time that the radio 506 is in an active mode. If the radio 506 is costly in power consumption, avoiding an unnecessary wake up of the radio 506 may reduce power consumption at the UE 502. If the radio 508 consumes very low power compared to the radio 506, the radio 508 may be configured to frequently monitor for LP-WUS signals to meet latency conditions of the UE 502. In some aspects, the radio 508 may be configured for paging reception from the TRP 504 and/or the TRP 505. In some aspects, the radio 508 may be configured to monitor for other LP signals, such as an LP reference signal (LP-RS). The UE 502 may use the LP-RS for time tracking or frequency tracking. The UE 502 may use the LP-RS for radio resource management (RRM) measurements. By monitoring LP-RS signals, the UE 502 may offload serving cell RRM from the radio 506 to the radio 508 to reduce the frequency for the radio 506 to be in active mode and to help save power at the UE 502.

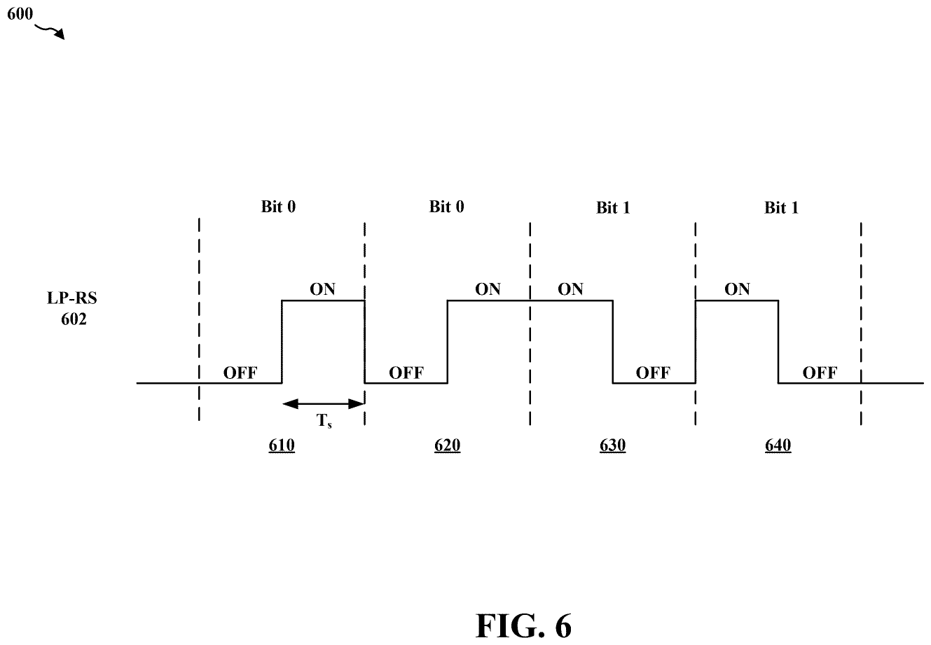

FIG. 6 is a diagram 600 illustrating an LP-RS 602, which may be an on-off keying (OOK)-based waveform. The baseline LP-RS 602 may be constructed by a transmitting device, such as the TRP 504 or the TRP 505 in FIGS. 5A and 5B, by repeating a mother signal S over consecutive symbols based on a binary index sequence and a Manchester coding scheme. The LP-RS 602 may include four bits, bit 610, bit 620, bit 630, and bit 640. Bit 610 and bit 620 both convey a zero value. Bit 630 and bit 640 both convey a one value.

When a corresponding index is one, the symbol may start with an S (on signal) followed by a zero (off signal). When a corresponding index is zero, the symbol may start with a zero (off signal) followed by an S (on signal). The mother signal S may be generated by an inverse fast Fourier transform (IFFT) output of a Zadoff-Chu sequence mapped to a number of subcarriers. The sequence length may be used to define the signal bandwidth of the LP-RS 602. The mother signal S may not be used to signal to a UE when the LP-WUR uses the envelope detector for detecting the LP-RS. In some aspects, the binary index sequence may have good auto-correlation properties and cross-correlation properties. For example, the binary index sequence may have a Gold sequence, and may provide a cell ID.

While the LP-RS 602 may be based off of an OOK waveform as shown, an LP-RS may be based off of any waveform of low complexity, such as an amplitude-shift keying-based modulated waveform.

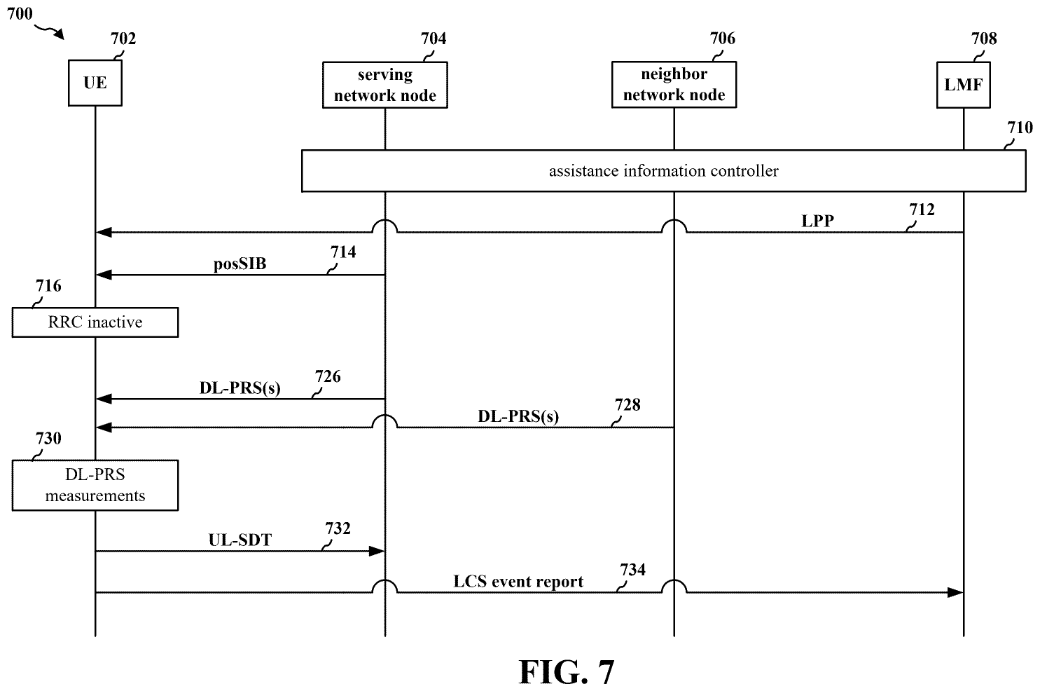

FIG. 7 is a communication flow diagram 700 of a UE 702, such as the UE 104 in FIG. 1 or the UE 502 in FIGS. 5A and 5B, configured to communicate with the serving network node 704, one or more neighbor network nodes, such as the neighbor network node 706, and a location management function (LMF) 708. In some aspects, the UE 702 may be configured to perform positioning measurements while the UE 702 is in a radio resource control (RRC) inactive state. By configuring the UE 702 to perform positioning measurements while the UE 702 is in an RRC inactive state, the UE 702 may perform positioning measurements without switching to an RRC connected mode or RRC connected state. The UE 702 may have an HPR, such as the radio 506 in FIGS. 5A and 5B, which may measure DL-PRSs from a network node, for example the set of DL-PRSs 726 from the serving network node 704 or the set of DL-PRSs 728 from the neighbor network node 706.

An assistance information controller 710 may be configured to communicate with the serving network node 704, the neighbor network node 706, and the LMF 708. The assistance information controller 710 may be, for example, the core network 120, the Near-RT RIC 125, or the Non-RT RIC 115 in FIG. 1. The assistance information controller 710 may provide assistance data to support downlink (DL) positioning while the UE 702 is in RRC inactive mode. In one aspect, the LMF 708 may generate a long term evolution (LTE) positioning protocol (LPP) message using the assistance information controller 710 to configure the UE 702 for DL positioning. The LPP message may include, for example, a non-access stratum (NAS) message. The LMF 708 may transmit an LPP 712 to the UE 702. The UE 702 may receive the LPP 712 from the LMF 708. The LPP may include assistance data that includes a configuration of DL-PRSs 726 or the set of DL-PRSs 728. In other aspects, the serving network node 704 may generate a positioning system information block (posSIB) using the assistance information controller 710 to configure the UE 702 for DL positioning. The serving network node 704 may transmit the posSIB 714 to the UE 702. The UE 702 may receive the posSIB from the serving network node.

At 716, the UE 702 may switch to an RRC inactive mode. The UE 702 may have been preconfigured for DL positioning using the LPP 712 and/or the posSIB 714. At 730, the UE 702 may perform positioning measurements based on the sets of received DL-PRSs. The serving network node 704 may transmit a set of DL-PRSs 726, which may be used for positioning. The neighbor network node 706 may transmit a set of DL-PRSs 728 which may be used for positioning. The UE 702 may have an HPR configured to be in active mode to receive the set of DL-PRSs. The UE 702 may receive the set of DL-PRSs 726 from the serving network node 704. The UE 702 may receive the set of DL-PRSs 728 from the neighbor network node 706. While one neighbor network node is shown in the communication flow diagram 700 in FIG. 7, the UE 702 may receive DL-PRSs from a plurality of neighbor network nodes in other aspects.

At 730, the UE 702 may measure the sets of DL-PRSs. The UE 702 may measure the set of DL-PRSs 726 received from the serving network node 704. The UE 702 may measure the set of DL-PRSs 728 received from the neighbor network node 706. In some aspects, the UE 702 may transmit a measurement report as the uplink (UL) small data transmission (UL-SDT) 732 to the serving network node 704. The UE 702 may transmit the UL-SDT 732 from its HPR. In some aspects, the UE 702 may transmit a location service (LCS) event report 734 to the LMF 708. The LCS event report 734 may be based on the measurements taken at 730. The UE 702 may transmit the LCS event report 734 from its HPR. In summary, the UE 702 may transmit the measurements it took at 730 without transitioning to an RRC connected state, remaining in RRC inactive mode while transmitting the UL-SDT 732 and/or the LCS event report 734.

While the UE 702 may be configured to periodically measure all DL-PRSs using its HPR to frequently update a priority for measuring the DL-PRSs, use of the HPR so frequently may consume a great deal of power. In some aspects, the UE 702 may be configured to configure the set of DL-PRSs 726 and the set of DL-PRSs 728 to align with the paging discontinuous reception (DRX) cycle of the UE 702, which may allow the UE 702 to put its HPR to sleep and switch to an active mode periodically to receive the DL-PRSs. However, a network may transmit DL-PRSs to a plurality of UEs in a cell, and a paging DRX cycle may be specific to each UE. Configuring the set of DL-PRSs 726 and the set of DL-PRSs 728 to align with the paging DRX cycle of the UE 702 may prevent other UEs from receiving the DL-PRSs that are not aligned with the DRX cycle of the UE 702. While the network may adjust the configuration of DL-PRSs (e.g., periodicity, offset, duration) for some of the UEs that are in RRC connected mode, the network may not be able to adjust the configuration of DL-PRSs for the UEs that are in RRC idle mode. In some aspects, the UE 702 may be configured to monitor the set of DL-PRSs using an LPR instead of its HPR. However, some LPRs may not be configured to receive the set of DL-PRSs. For example, the serving network node 704 may transmit the set of DL-PRSs 726 using an OFDM waveform, but the LPR of the UE 702 may have a lower complexity decoder does not support OFDM waveforms (e.g., envelope detector based).

Thus, it may be beneficial to improve positioning techniques using an LPR to save power at the UE, for example by using an LP-RS design that may be received and measured by an LPR, for example a low complexity LP-WUR. The LP-RS may be constructed based on an OOK-based waveform, for example the LP-RS 602 in FIG. 6 or another low complexity waveform, such as an amplitude-shift keying-based modulated waveform. Such LP-RSs may be monitored by an LPR, such as an LP-WUR, for positioning measurements to reduce UE power consumption. In one aspect, a second network node may transmit, for a UE, a configuration of a set of LP-PRSs. The UE may receive the configuration of the set of LP-PRSs. A first network node may transmit, for the UE, the set of LP-PRSs to an LP-WUR of the UE. The UE may receive the set of LP-PRSs using the LP-WUR. The first network node may transmit an LP-WUS including an indication to measure the set of LP-PRSs. The UE may receive the LP-WUS including the indication to measure the set of LP-PRSs. The UE may measure the set of LP-PRSs based on the configuration of the set of LP-PRSs and the indication to measure the set of LP-PRSs.

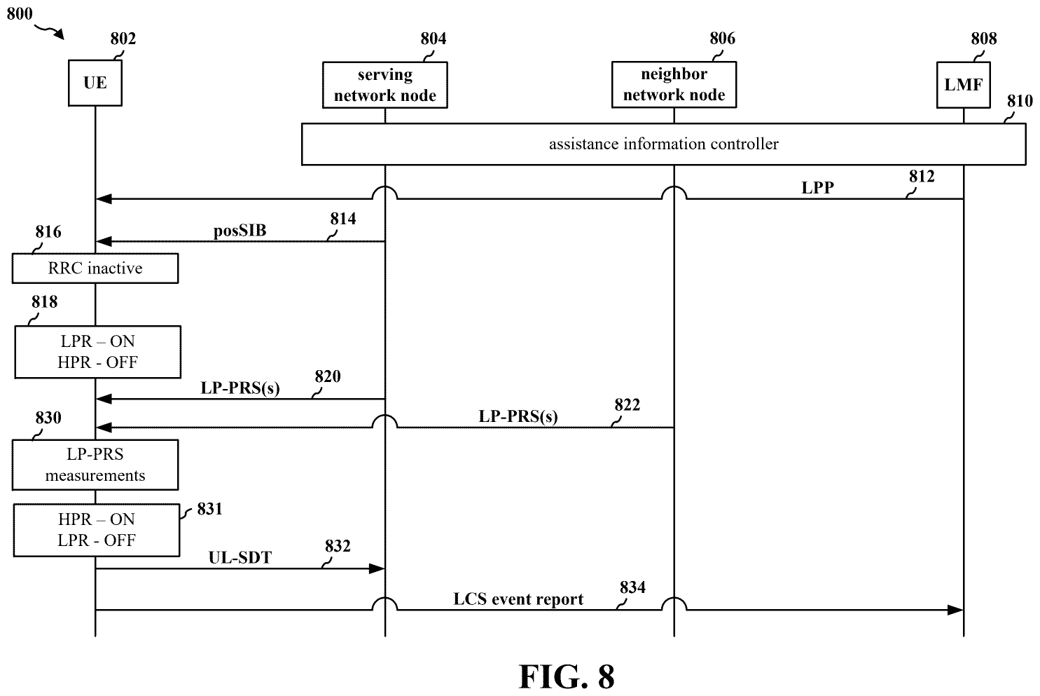

FIG. 8 is a communication flow diagram 800 of a UE 802, such as the UE 104 in FIG. 1 or the UE 502 in FIGS. 5A and 5B, configured to communicate with the serving network node 804, one or more neighbor network nodes, such as the neighbor network node 806, and an LMF 808. In some aspects, the UE 802 may be configured to perform positioning measurements while the UE 802 is in an RRC inactive state. By configuring the UE 802 to perform positioning measurements while the UE 802 is in an RRC inactive state, the UE 802 may perform positioning measurements without switching to an RRC connected mode or RRC connected state. The UE 802 may have an HPR, such as the radio 506 in FIGS. 5A and 5B, which may receive configuration information for one or more sets of LP-PRSs from a network node, for example the set of LP-PRSs 820 from the serving network node 804 or the set of LP-PRSs 822 from the neighbor network node 806.

An assistance information controller 810 may be configured to communicate with the serving network node 804, the neighbor network node 806, and the LMF 808. The assistance information controller 810 may be, for example, the core network 120, the Near-RT RIC 125, or the Non-RT RIC 115 in FIG. 1. The assistance information controller 810 may provide assistance data to support DL positioning using LP-RSs, such as LP-PRSs, while the UE 802 is in RRC inactive mode. In one aspect, the LMF 808 may generate an LPP message using the assistance information controller 810 to configure the UE 802 for DL positioning (e.g., positioning measurement based on LP-PRSs). The LPP message may include, for example, a NAS message. The LMF 808 may transmit an LPP 812 to the UE 802. The UE 802 may receive the LPP 812 from the LMF 808. The LPP 812 may include assistance data for positioning measurement. The assistance data may include a configuration of LP-PRSs, such as the set of LP-PRSs 820 from the serving network node 804 and/or the set of LP-PRSs 822 from the neighbor network node 806. Each of the set of LP-PRSs 820 and the set of LP-PRSs 822 may be considered subsets of a set of LP-PRSs configured by assistance data. In other aspects, the serving network node 804 may generate a positioning system information block (posSIB) using the assistance information controller 810 to configure the UE 802 for DL positioning. The serving network node 804 may transmit the posSIB 814 to the UE 802. The UE 802 may receive the posSIB from the serving network node. The posSIB 814 may include assistance data for positioning measurement. The positioning measurement may include a configuration of one or more sets of LP-PRSs, such as the set of LP-PRSs 820 from the serving network node 804 and/or the set of LP-PRSs 822 from the neighbor network node 806. The positioning measurement based on the LP-PRSs may be applied to an enhanced cell ID (E-CID). The positioning measurement based on the LP-PRSs may be applied to DL angle of departure (DL-AoD)-based positioning methods.

At 816, the UE 802 may switch to an RRC inactive mode. The UE 802 may have been preconfigured for DL positioning using the LPP 812 and/or the posSIB 814. At 818, the UE 802 may switch its HPR to an OFF mode, or a sleep mode, and may switch its LPR to an ON mode, or an active mode. In some aspects, the UE 802 may be configured to always have its LPR in active mode whether RRC connected or not RRC connected, as the LPR may not consume much power. The serving network node 804 may transmit the set of LP-PRSs 820 to the UE 802. The UE 802 may receive the set of LP-PRSs 820 from the serving network node 804. The neighbor network node 806 may transmit the set of LP-PRSs 822 to the UE 802. The UE 802 may receive the set of LP-PRSs 822 from the neighbor network node 806. While one neighbor network node is shown in FIG. 8, a plurality of neighbor network nodes may be configured to transmit sets of LP-PRSs to the UE 802. The UE 802 may have an LPR configured to be in active mode to receive the set of LP-PRSs.

In some aspects, the wireless devices transmitting the set of LP-PRSs to the UE 802, such as the serving network node 804 transmitting the set of LP-PRSs 820 and the neighbor network node 806 transmitting the set of LP-PRSs 822, may be configured to transmit the set of LP-PRSs based on a minimal signal duration. The minimal signal duration may be, for example, at least 40 milliseconds (ms). In other words, the transmitting devices may support a sufficiently long signal duration to enable one-shot detection even for a low SNR of the LPR of the UE 802 to reduce positioning latency. The transmitting devices may be configured to use a long signal duration in conjunction with a large periodicity to ensure that the overhead of the LP-PRS is not over a threshold value, for example more than 200 ms per second.

In some aspects, a transmitting device, such as the serving network node 804 transmitting the set of LP-PRSs 820 and the neighbor network node 806 transmitting the set of LP-PRSs 822, may be configured to use either a long sequence or a short sequence spreading by a cover code. In one aspect, the transmitting device may use a long signal duration. The transmitting device may use a length for an LP-PRS to be equal to a total number of symbols in the duration of the LP-PRS. In another aspect, the transmitting device may use a short signal LP-PRS sequence with a cover code. The transmitting device may split an LP-PRS time domain signal into a number of segments (e.g., N segments, or repeated copies), where the sequence for the i-th segment may be defined by dᵢ(n)=c(n)⊕b(i), where b(i) may be the cover code, c(n) may be the short LP-PRS sequence, and ⊕ may denote binary addition. In some aspects, the transmitting device may design the binary cover code to enable combinations to accumulate the correlation results across repetitions in an unambiguous fashion. In some aspects, the cover code may be all zero values, which may result in a simple repetition of the short sequence used in each segment.

At 830, the UE 802 may perform positioning measurements based on the sets of received LP-PRSs. The UE 802 may measure the set of LP-PRSs 820 received from the serving network node 804. The UE 802 may measure the set of LP-PRSs 822 received from the neighbor network node 806. The measurement of the set of LP-PRSs 820 and/or the set of LP-PRSs 822 may be based on a configuration in the assistance data, for example resources allocated to the LP-PRSs indicated by the configuration or a schedule of the LP-PRSs indicated by the configuration. In some aspects, the UE 802 may calculate an RSRP of the set of LP-PRSs 820 and/or the set of LP-PRSs 822 based on measuring the sets of LP-PRSs. In some aspects, the UE 802 may calculate a reference signal strength indicator (RSSI) of the set of LP-PRSs 820 and/or the set of LP-PRSs 822 based on measuring the sets of LP-PRSs. The UE 802 may generate a measurement report based on the calculated RSRP and/or the calculated RSSI of the sets of LP-PRSs.

At 831, the UE may switch its HPR to the ON, or active mode, and may switch its LPR to the OFF, or inactive mode. In some aspects, the UE 802 may transmit the measurement report as the UL-SDT 832 to the serving network node 804. The UE 802 may transmit the UL-SDT 832 from its HPR. In some aspects, the UE 802 may transmit the measurement report as an LCS event report 834 to the LMF 808. The LCS event report 834 may be based on the measurements taken at 830. The UE 802 may transmit the LCS event report 834 from its HPR. In summary, the UE 802 may transmit the measurements it took at 830 without transitioning to an RRC connected state, remaining in RRC inactive mode and conserving power by keeping its HPR in a sleep mode while receiving and measuring sets of LP-PRS. The UE 802 may switch its HPR to an active mode to transmit the UL-SDT 832 and/or the LCS event report 834 based on measurements of the sets of LP-PRSs. The UL-SDT 832 may include a plurality of transmissions, for example one having a measurement report for the set of LP-PRSs 820 and another having a measurement report for the set of LP-PRSs 822. The LCS event report 834 may include a plurality of transmissions, for example one having a measurement report for the set of LP-PRSs 820 and another having a measurement report for the set of LP-PRSs 822.

The set of LP-PRS may be configured to be periodic, semi-persistent, or aperiodic. In some aspects, an LP-WUS may be used to trigger a positioning measurement on an LP-PRS, or an LP-WUS may be used to indicate the presence of an LP-PRS. For example, the serving network node 804 may transmit an LP-WUS to the UE 802 before a transmission of the set of LP-PRSs 820, and the neighbor network node 806 may transmit an LP-WUS to the UE 802 before a transmission of the set of LP-PRSs 822. In other words, the set of LP-PRSs 820 in the communication flow diagram 800 may be considered to include an LP-WUS followed by a set of LP-PRSs, and/or the set of LP-PRSs 822 may be considered to include an LP-WUS followed by a set of LP-PRSs. In some aspects, in response to receiving an LP-WUS that indicates the presence of an LP-PRS, the UE 802 may reconfigure one or more components of its LPR for receiving and/or decoding the LP-PRSs. In one aspect, the UE 802 may reconfigure an analog-to-digital converter (ADC) of its LPR to use more bits to receive or measure the set of LP-PRSs 820 or the set of LP-PRSs 822. For example, the UE 802 may reconfigure its ADC from a single bit operation to a multiple bit operation. The UE 802 may reconfigure one or more components in response to receiving an LP-WUS that indicates a set of LP-PRSs.

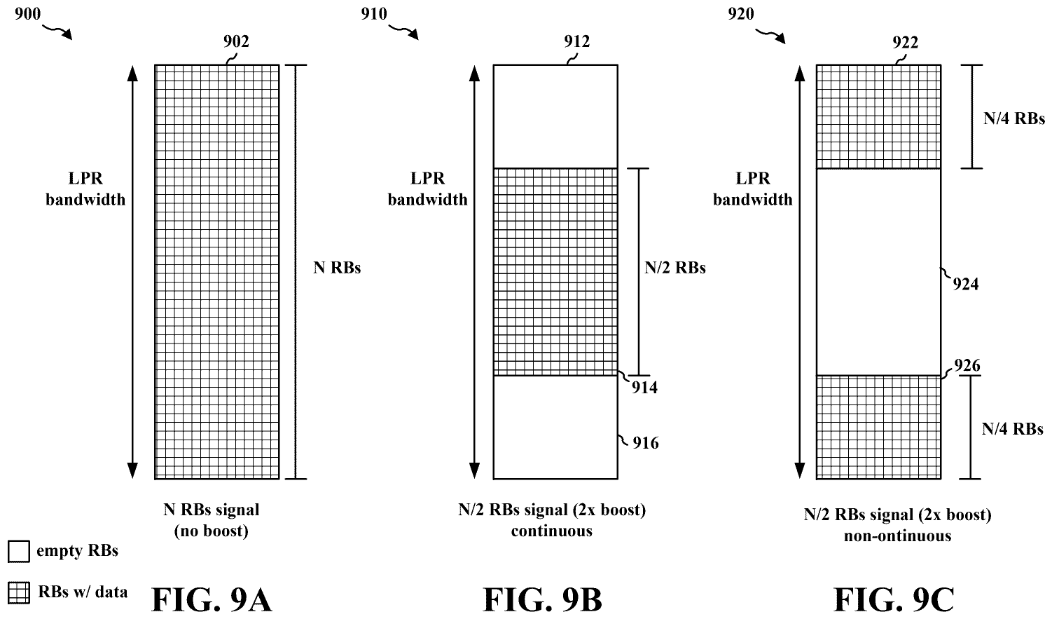

The sets of LP-PRSs may be configured with a reduced signal bandwidth to support a low signal-to-noise radio (SNR). FIG. 9A is a diagram 900 illustrating an example of LP-PRSs having a reduced signal bandwidth.

FIG. 9A is a diagram 900 illustrating an example of an LP-RS having a normal signal bandwidth. The signal 902 may span the entire bandwidth of the LPR of a UE, such as the radio 508 in FIGS. 5A and 5B. The signal 902 may use N resource blocks (RB), which spans the entirety of the bandwidth that the LPR of the UE may receive and measure. The signal 902 may represent an LP-WUS transmitted from a network node to the UE, which may use an entirety of the signal bandwidth that an LPR of the UE may be capable of receiving.

FIG. 9B is a diagram 910 illustrating an example of an LP-RS having a reduced, continuous signal bandwidth as compared with the LP-RS of diagram 900 in FIG. 9A. The signal 914 may not use the RBs of the section 912 of the LPR bandwidth or the section 916 of the LPR bandwidth. The signal 914 may use N/2 RBs of the LPR bandwidth. The smaller bandwidth allows the LPR to process the signal 914 at a lower sampling rate. This may reduce the complexity at the UE and may also reduce power consumption at the UE, while maintaining good detection performance. In some aspects, the transmitting network node, such as the serving network node 804 or the neighbor network node 806 in FIG. 8, may employ power boosting on signals with a smaller bandwidth to ensure that the total received signal power of the signal 914 as compared to the signal 902 is not reduced by a threshold amount. The signal 914 may represent an LP-PRS transmitted from a network node to the UE. By using a smaller signal bandwidth for an LP-PRS (e.g., signal 914 in diagram 910) than for an LP-WUS (e.g., signal 902 in diagram 900), the UE may use less measurement complexity to receive and/or measure the LP-PRS than the LP-WUS. By using a smaller signal bandwidth for an LP-PRS than for an LP-WUS, the network node may transmit the LP-PRS having a higher power level than the LP-WUS, which may increase an SNR of the LP-PRS as compared with the LP-WUS.

FIG. 9C is a diagram 920 illustrating an example of an LP-RS having a first part 922 and a second part 926 in a reduced, non-continuous signal bandwidth. The LP-RS may not use the RBs of the section 924 of the LPR bandwidth. The first part 922 of the signal and the second part 926 of the signal may use N/2 RBs in total, similar to the signal 914 of diagram 910 in FIG. 9B. The smaller bandwidth, again, may the LPR to process the LP-RS of diagram 920 at a lower sampling rate than the signal 902 of diagram 900 in FIG. 9A. The non-continuous bandwidth may provide better frequency diversity. While the signal in diagram 920 is shown as being split into two parts, a signal may be split into more than two parts in other aspects, such as three, four, or more parts. The UE may use additional processing overhead to separate out the narrowband components of the signal and re-combine them appropriately before an envelope detector. In some aspects, the UE may re-combine the first part 922 of the signal and the second part 926 of the signal by concatenating the RBs. The signal combined first part 922 of the signal and the second part 926 of the signal may represent an LP-PRS transmitted from a network node to the UE.

In some aspects, the sets of LP-PRSs may be configured with a repetition pattern to improve performance and the SNR.

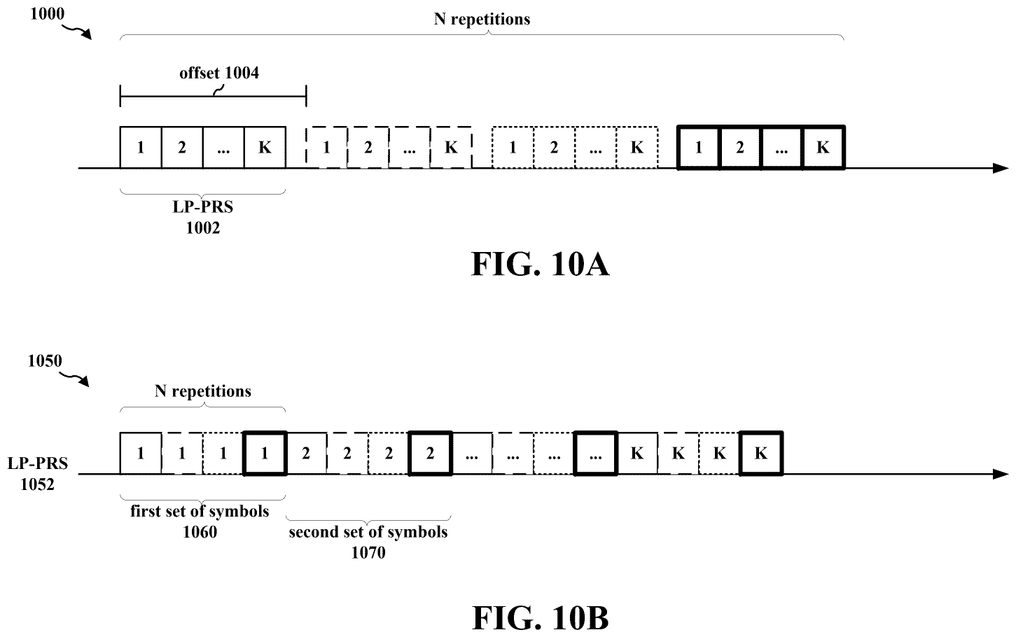

FIG. 10A is a diagram 1000 illustrating an example of a repetition pattern for an LP-PRS 1002. The LP-PRS 1002 may be mapped to K symbols from 1 to K in sequence. The LP-PRS 1002 may be repeated based on the offset 1004. The LP-PRS 1002 may be repeated N times. The number of symbols K, the number of repetitions N, and the offset 1004 may each be configured by a network entity, such as the LMF 808 in FIG. 8 or the assistance information controller 810. In some aspects, a network entity may improve performance by allowing coherent combining of LP-PRSs across repetitions.

FIG. 10B is a diagram 1050 illustrating an example of another repetition pattern for an LP-PRS 1052. The LP-PRS 1052 may map a number of repetitions N for each symbol of an LP-PRS. After mapping one modulated symbol, the symbol may be repeated N times to complete a set of symbols, such as the first set of symbols 1060. The transmitting node may then continue mapping other modulated symbols, and repeat that symbol N times to complete the symbol. For example, after repeating the first modulated symbol N times to generate the first set of symbols 1060, the transmitting node may repeat the second modulated symbol N times to generate the second set of symbols 1070, until all K symbols have been generated. The LP-PRS 1052 may have a better performance than the LP-PRS 1002 in FIG. 10A, as the LP-PRS 1052 may have a relaxed specification on memory access if demodulation results are stored in an external memory. The repetition pattern for the LP-PRS 1052 may also be referred to as a set of non-sequential symbols, as the second symbol does not immediately follow the first symbol. Instead, the first symbol is repeated N times as the first set of symbols 1060 until the second set of symbols is repeated N times as the second set of symbols 1070.

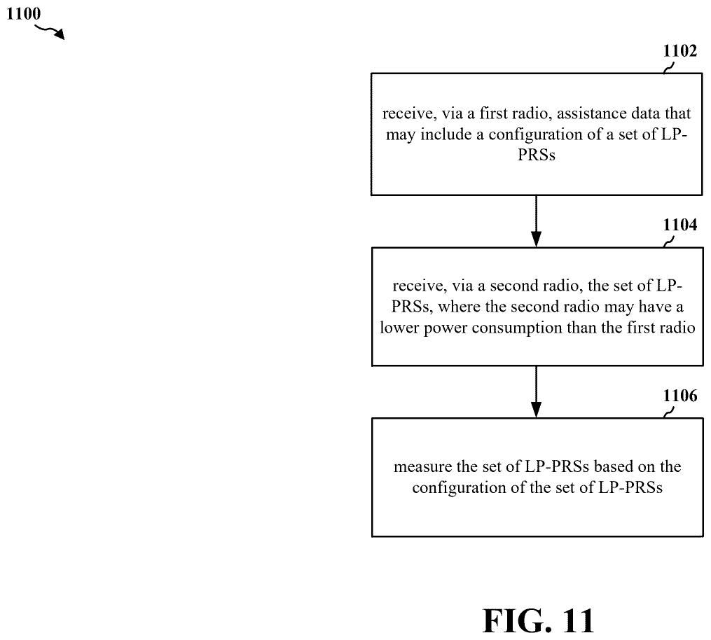

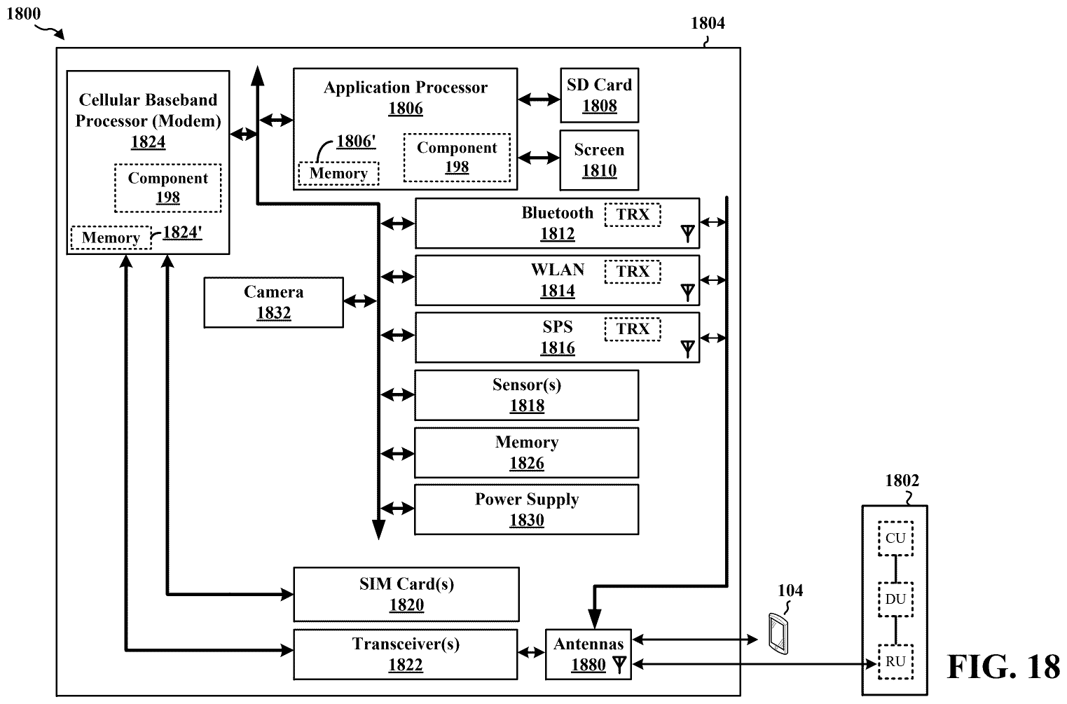

FIG. 11 is a flowchart 1100 of a method of wireless communication. The method may be performed by a UE (e.g., the UE 104, the UE 350, the UE 404, the UE 502, the UE 702, the UE 802; the apparatus 1804). At 1102, the UE may receive, via a first radio, assistance data that may include a configuration of a set of LP-PRSs. For example, 1102 may be performed by the UE 802 in FIG. 8, which may receive, via an HPR of the UE 802, the LPP 812 that may include assistance data including a configuration of a set of LP-PRSs, such as the set of LP-PRSs 820 and/or the set of LP-PRSs 822. 1102 may also be performed by the UE 802 in FIG. 8, which may receive, via an HPR of the UE 802, the posSIB 814 that may include assistance data including a configuration of a set of LP-PRSs, such as the set of LP-PRSs 820 and/or the set of LP-PRSs 822. Moreover, 1102 may be performed by the component 198 in FIG. 18.

At 1104, the UE may receive, via a second radio, the set of LP-PRSs, where the second radio may have a lower power consumption than the first radio. For example, 1104 may be performed by the UE 802 in FIG. 8, which may receive, via an LPR of the UE 802, the set of LP-PRSs 820 and/or the set of LP-PRSs 822. The LPR of the UE 802 may have a lower power consumption than the HPR of the UE 802. Moreover, 1104 may be performed by the component 198 in FIG. 18.

At 1106, the UE may measure the set of LP-PRSs based on the configuration of the set of LP-PRSs. For example, 1106 may be performed by the UE 802 in FIG. 8, which may, at 803, measure the set of LP-PRSs 820 and/or the set of LP-PRSs 822 based on the configuration of the set of LP-PRSs from the assistance data of the LPP 812 or the posSIB 814. Moreover, 1106 may be performed by the component 198 in FIG. 18.

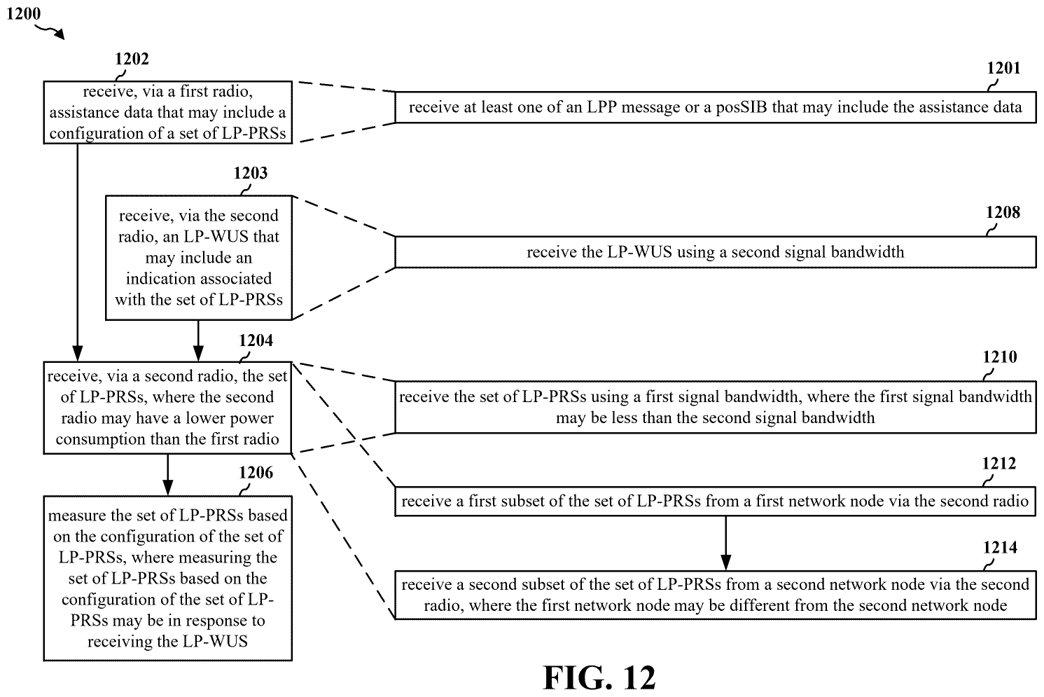

FIG. 12 is a flowchart 1200 of a method of wireless communication. The method may be performed by a UE (e.g., the UE 104, the UE 350, the UE 404, the UE 502, the UE 702, the UE 802; the apparatus 1804). At 1201, the UE may receive at least one of an LPP message or a posSIB that may include the assistance data. For example, 1201 may be performed by the UE 802 in FIG. 8, which may receive at the LPP 812 from the LMF 808 or the posSIB 814 from the serving network node 804 that may include the assistance data. Moreover, 1201 may be performed by the component 198 in FIG. 18.

At 1202, the UE may receive, via a first radio, assistance data that may include a configuration of a set of LP-PRSs. For example, 1202 may be performed by the UE 802 in FIG. 8, which may receive, via an HPR of the UE 802, the LPP 812 that may include assistance data including a configuration of a set of LP-PRSs, such as the set of LP-PRSs 820 and/or the set of LP-PRSs 822. 1202 may also be performed by the UE 802 in FIG. 8, which may receive, via an HPR of the UE 802, the posSIB 814 that may include assistance data including a configuration of a set of LP-PRSs, such as the set of LP-PRSs 820 and/or the set of LP-PRSs 822. Moreover, 1202 may be performed by the component 198 in FIG. 18.

At 1203, the UE may receive, via the second radio, an LP-WUS that may include an indication associated with the set of LP-PRSs. For example, 1203 may be performed by the UE 802 in FIG. 8, which may receive, via the LPR at the UE 802, an LP-WUS that may include an indication associated with the set of LP-PRSs. For example, the set of LP-PRSs 820 may include an LP-WUS followed by a set of LP-PRSs and the set of LP-PRSs 822 may include an LP-WUS followed by a set of LP-PRSs. Moreover, 1203 may be performed by the component 198 in FIG. 18.

At 1204, the UE may receive, via a second radio, the set of LP-PRSs, where the second radio may have a lower power consumption than the first radio. For example, 1204 may be performed by the UE 802 in FIG. 8, which may receive, via an LPR of the UE 802, the set of LP-PRSs 820 and/or the set of LP-PRSs 822. The LPR of the UE 802 may have a lower power consumption than the HPR of the UE 802. Moreover, 1204 may be performed by the component 198 in FIG. 18.

At 1206, the UE may measure the set of LP-PRSs based on the configuration of the set of LP-PRSs. For example, 1206 may be performed by the UE 802 in FIG. 8, which may, at 803, measure the set of LP-PRSs 820 and/or the set of LP-PRSs 822 based on the configuration of the set of LP-PRSs from the assistance data of the LPP 812 or the posSIB 814. Moreover, 1206 may be performed by the component 198 in FIG. 18.

At 1208, the UE may receive the LP-WUS using a second signal bandwidth. For example, 1208 may be performed by the UE 802 in FIG. 8, which may receive the LP-WUS using a second signal bandwidth, such as the bandwidth of the signal 902 in FIG. 9A which uses all N RBs of the LPR bandwidth. Moreover, 1208 may be performed by the component 198 in FIG. 18.

At 1210, the UE may receive the set of LP-PRSs using a first signal bandwidth. The first signal bandwidth may be less than the second signal bandwidth. For example, 1210 may be performed by the UE 802 in FIG. 8, which may receive the set of LP-PRSs using a first signal bandwidth, such as the bandwidth of the signal 914 in FIG. 9B which uses N/2 RBs of the LPR bandwidth or the bandwidth of the signal having the first part 922 and the second part 926 in FIG. 9C which uses N/2 RBs of the LPR bandwidth. The bandwidth of the signal 914 in FIG. 9B or the bandwidth of the signal having the first part 922 and the second part 926 in FIG. 9C are both less than the bandwidth of the signal 902 in FIG. 9A. Moreover, 1210 may be performed by the component 198 in FIG. 18.

At 1212, the UE may receive a first subset of the set of LP-PRSs from a first network node via the second radio. For example, 1212 may be performed by the UE 802 in FIG. 8, which may receive the set of LP-PRSs 820 from the serving network node 804 via the LPR of the UE 802. 1212 may be performed by the UE 802 in FIG. 8, which may receive the set of LP-PRSs 822 from the neighbor network node 806 via the LPR of the UE 802. Moreover, 1212 may be performed by the component 198 in FIG. 18.

At 1214, the UE may receive a second subset of the set of LP-PRSs from a second network node via the second radio. The first network node may be different from the second network node. For example, 1214 may be performed by the UE 802 in FIG. 8, which may receive the set of LP-PRSs 822 from the neighbor network node 806 via the LPR at the UE 802. The neighbor network node 806 is different than the serving network node 804, from which the UE 802 receives the set of LP-PRSs 820. 1214 may be performed by the UE 802 in FIG. 8, which may receive the set of LP-PRSs 820 from the serving network node 804 via the LPR at the UE 802. The serving network node 804 is different than the neighbor network node 806, from which the UE 802 receives the set of LP-PRSs 822. Moreover, 1214 may be performed by the component 198 in FIG. 18.

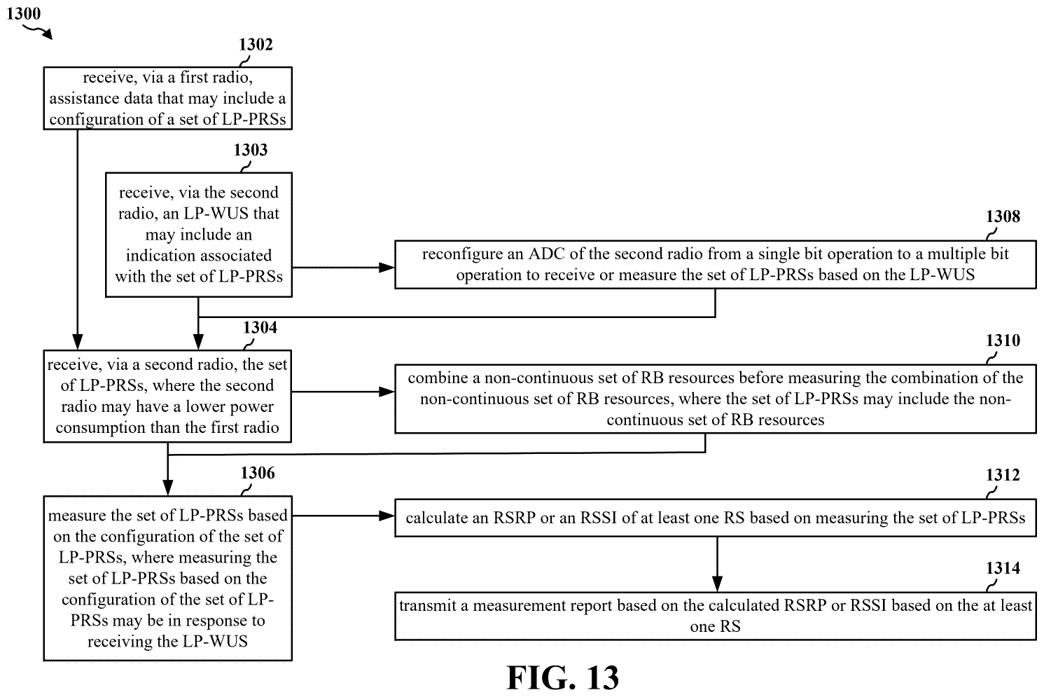

FIG. 13 is a flowchart 1300 of a method of wireless communication. The method may be performed by a UE (e.g., the UE 104, the UE 350, the UE 404, the UE 502, the UE 702, the UE 802; the apparatus 1804). At 1302, the UE may receive, via a first radio, assistance data that may include a configuration of a set of LP-PRSs. For example, 1302 may be performed by the UE 802 in FIG. 8, which may receive, via an HPR of the UE 802, the LPP 812 that may include assistance data including a configuration of a set of LP-PRSs, such as the set of LP-PRSs 820 and/or the set of LP-PRSs 822. 1302 may also be performed by the UE 802 in FIG. 8, which may receive, via an HPR of the UE 802, the posSIB 814 that may include assistance data including a configuration of a set of LP-PRSs, such as the set of LP-PRSs 820 and/or the set of LP-PRSs 822. Moreover, 1302 may be performed by the component 198 in FIG. 18.

At 1303, the UE may receive, via the second radio, an LP-WUS that may include an indication associated with the set of LP-PRSs. For example, 1303 may be performed by the UE 802 in FIG. 8, which may receive, via the LPR at the UE 802, an LP-WUS that may include an indication associated with the set of LP-PRSs. For example, the set of LP-PRSs 820 may include an LP-WUS followed by a set of LP-PRSs and the set of LP-PRSs 822 may include an LP-WUS followed by a set of LP-PRSs. Moreover, 1303 may be performed by the component 198 in FIG. 18.

At 1304, the UE may receive, via a second radio, the set of LP-PRSs, where the second radio may have a lower power consumption than the first radio. For example, 1304 may be performed by the UE 802 in FIG. 8, which may receive, via an LPR of the UE 802, the set of LP-PRSs 820 and/or the set of LP-PRSs 822. The LPR of the UE 802 may have a lower power consumption than the HPR of the UE 802. Moreover, 1304 may be performed by the component 198 in FIG. 18.

At 1306, the UE may measure the set of LP-PRSs based on the configuration of the set of LP-PRSs. For example, 1306 may be performed by the UE 802 in FIG. 8, which may, at 803, measure the set of LP-PRSs 820 and/or the set of LP-PRSs 822 based on the configuration of the set of LP-PRSs from the assistance data of the LPP 812 or the posSIB 814. Moreover, 1306 may be performed by the component 198 in FIG. 18.

At 1308, the UE may reconfigure an ADC of the second radio from a single bit operation to a multiple bit operation to receive or measure the set of LP-PRSs based on the LP-WUS. For example, 1308 may be performed by the UE 802 in FIG. 8, which may, at 818, reconfigure an ADC of the LPR from a single bit operation to a multiple bit operation to receive or measure the set of LP-PRSs 820 and/or the set of LP-PRSs 822 based on the LP-WUS. Moreover, 1308 may be performed by the component 198 in FIG. 18.

At 1310, the UE may combine a non-continuous set of RB resources before measuring the combination of the non-continuous set of RB resources. The set of LP-PRSs may include the non-continuous set of RB resources. For example, 1310 may be performed by the UE 802 in FIG. 8, which may combine a non-continuous set of RB resources, such as the first part 922 and the second part 926 in FIG. 9C, before measuring the combination of the non-continuous set of RB resources. The set of LP-PRSs may include the non-continuous set of RB resources. Moreover, 1310 may be performed by the component 198 in FIG. 18.

At 1312, the UE may calculate an RSRP or an RSSI of at least one RS based on measuring the set of LP-PRSs. For example, 1312 may be performed by the UE 802 in FIG. 8, which may, at 830, calculate an RSRP or an RSSI of at least one RS based on measuring the set of LP-PRSs 820 and/or the set of LP-PRSs 822. Moreover, 1312 may be performed by the component 198 in FIG. 18.

At 1314, the UE may transmit a measurement report based on the calculated RSRP or RSSI based on the at least one RS. For example, 1314 may be performed by the UE 802 in FIG. 8, which may transmit a measurement report as the UL-SDT 832 to the serving network node 804 or the LCS event report 834 to the LMF 808 based on the calculated RSRP or RSSI based on the at least one RS. Moreover, 1314 may be performed by the component 198 in FIG. 18.

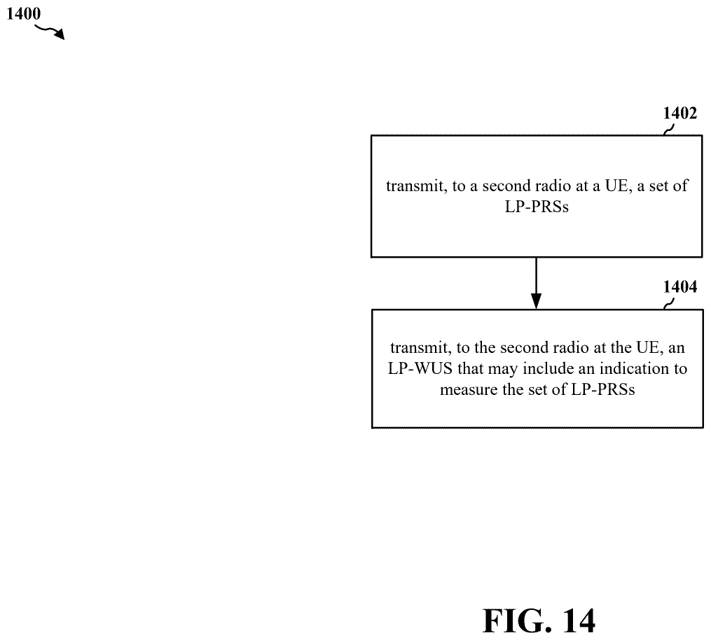

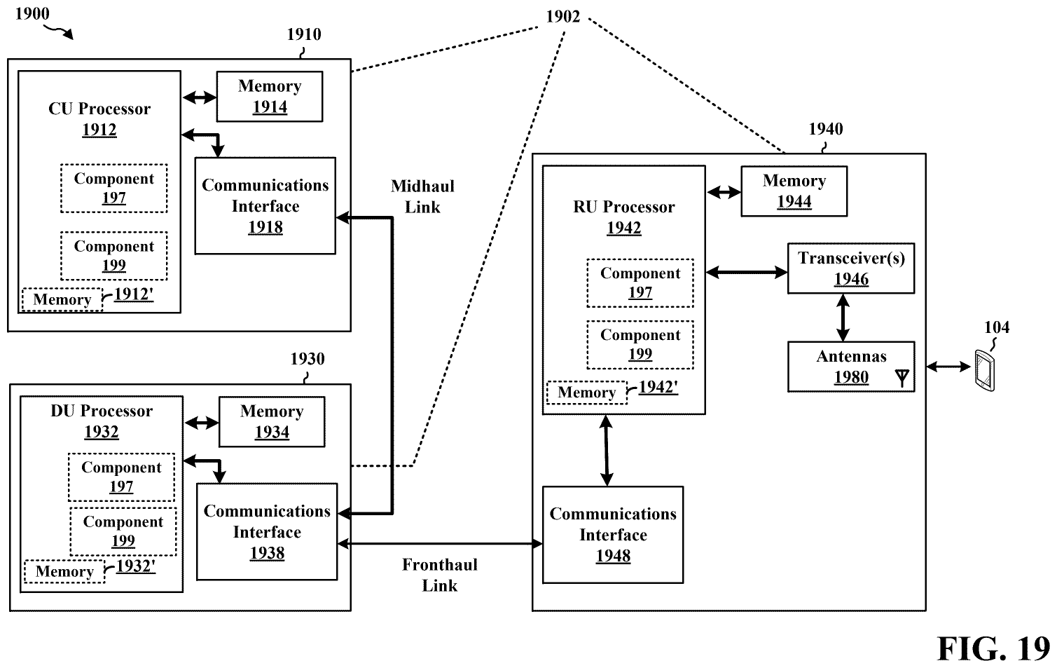

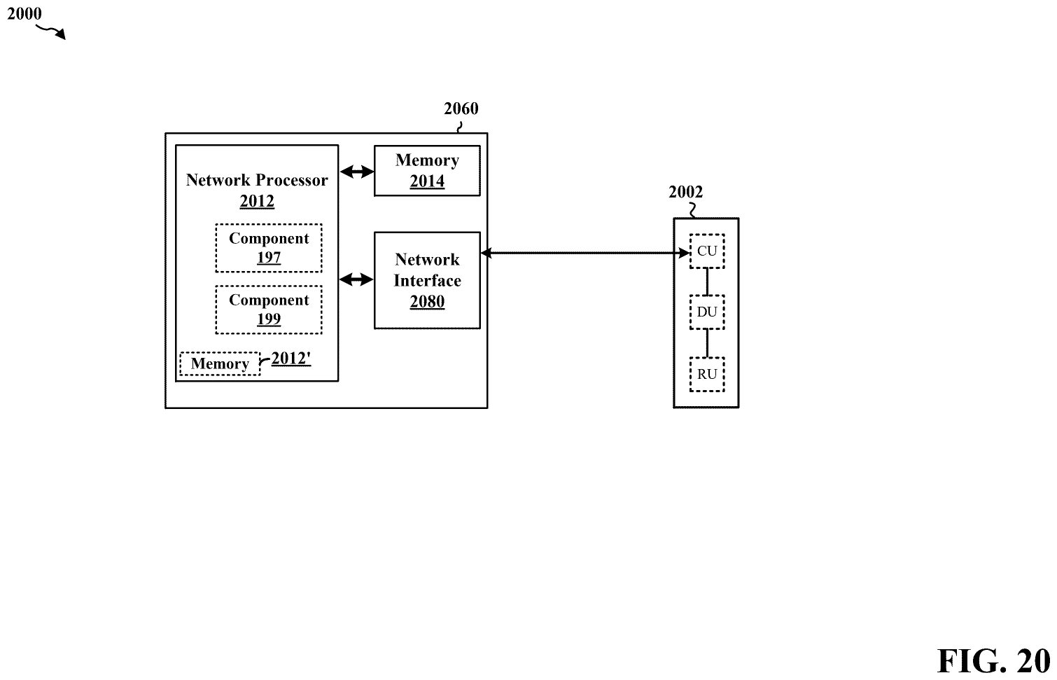

FIG. 14 is a flowchart 1400 of a method of wireless communication. The method may be performed by a first network node (e.g., the base station 102, the base station 310; the TRP 402, the TRP 406, the TRP 504, the TRP 505; the serving network node 704, the serving network node 804; the neighbor network node 706, the neighbor network node 806; the network entity 1802, the network entity 1902, the network entity 2060). At 1402, the first network node may transmit, to a second radio at a UE, a set of LP-PRSs. For example, 1402 may be performed by the serving network node 804 in FIG. 8, which may transmit, to an LPR at the UE 802, the set of LP-PRSs 820. 1402 may be performed by the neighbor network node 806 in FIG. 8, which may transmit, to an LPR at the UE 802, the set of LP-PRSs 822. Moreover, 1402 may be performed by the component 197 in FIG. 19 or 20.

At 1404, the first network node may transmit, to the second radio at the UE, an LP-WUS that may include an indication to measure the set of LP-PRSs. For example, 1404 may be performed by the serving network node 804 in FIG. 8, which may transmit, to the LPR at the UE 802, an LP-WUS as the set of LP-PRSs 820, which may include an indication to measure the set of LP-PRSs 820. 1404 may be performed by the neighbor network node 806 in FIG. 8, which may transmit, to the LPR at the UE 802, an LP-WUS as the set of LP-PRSs 822, which may include an indication to measure the set of LP-PRSs 822. Moreover, 1404 may be performed by the component 197 in FIG. 19 or 20.

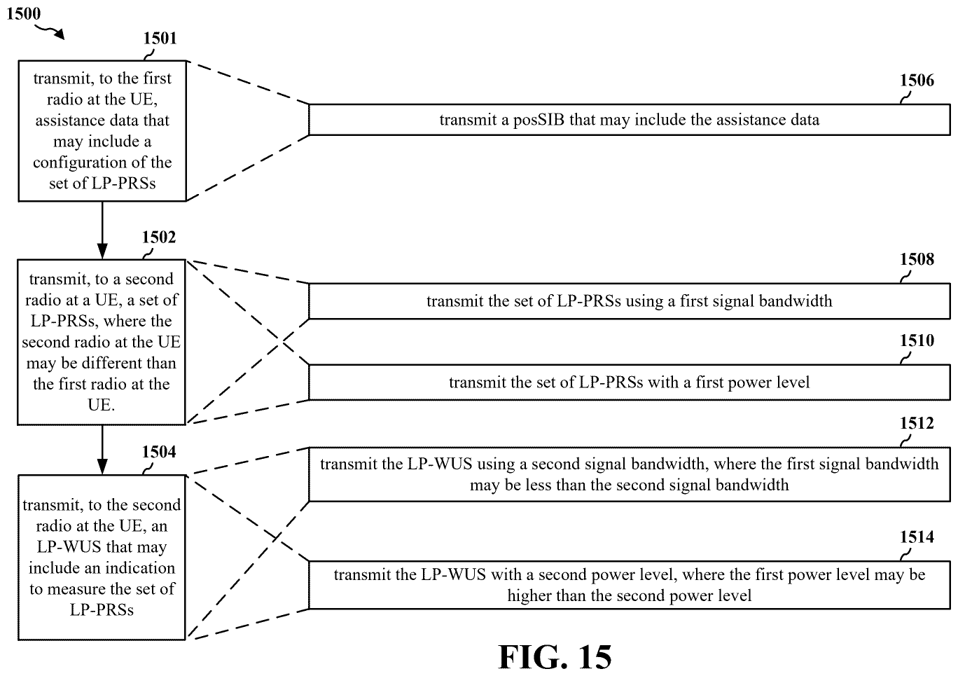

FIG. 15 is a flowchart 1500 of a method of wireless communication. The method may be performed by a first network node (e.g., the base station 102, the base station 310; the TRP 402, the TRP 406, the TRP 504, the TRP 505; the serving network node 704, the serving network node 804; the neighbor network node 706, the neighbor network node 806; the network entity 1802, the network entity 1902, the network entity 2060). At 1501, the first network node may transmit, to the first radio at the UE, assistance data that may include a configuration of the set of LP-PRSs. For example, 1501 may be performed by the serving network node 804 in FIG. 8, which may transmit, to the HPR at the UE 802, the posSIB 814 which may include assistance data including a configuration of the set of LP-PRSs 820 and/or the set of LP-PRSs 822. 1501 may be performed by the LMF 808 in FIG. 8, which may transmit, to the HPR at the UE 802, the LPP 812 which may include assistance data including a configuration of the set of LP-PRSs 820 and/or the set of LP-PRSs 822. Moreover, 1501 may be performed by the component 197 FIG. 19 or 20.

At 1502, the first network node may transmit, to a second radio at a UE, a set of LP-PRSs. For example, 1502 may be performed by the serving network node 804 in FIG. 8, which may transmit, to an LPR at the UE 802, the set of LP-PRSs 820. 1502 may be performed by the neighbor network node 806 in FIG. 8, which may transmit, to an LPR at the UE 802, the set of LP-PRSs 822. Moreover, 1502 may be performed by the component 197 in FIG. 19 or 20.

At 1504, the first network node may transmit, to the second radio at the UE, an LP-WUS that may include an indication to measure the set of LP-PRSs. For example, 1504 may be performed by the serving network node 804 in FIG. 8, which may transmit, to the LPR at the UE 802, an LP-WUS as the set of LP-PRSs 820, which may include an indication to measure the set of LP-PRSs 820. 1504 may be performed by the neighbor network node 806 in FIG. 8, which may transmit, to the LPR at the UE 802, an LP-WUS as the set of LP-PRSs 822, which may include an indication to measure the set of LP-PRSs 822. Moreover, 1504 may be performed by the component 197 in FIG. 19 or 20.

At 1506, the first network node may transmit a posSIB that may include the assistance data. For example, 1506 may be performed by the serving network node 804 in FIG. 8, which may transmit the posSIB 814 that may include the assistance data. Moreover, 1506 may be performed by the component 197 FIG. 19 or 20.

At 1508, the first network node may transmit the set of LP-PRSs using a first signal bandwidth. For example, 1508 may be performed by the serving network node 804 in FIG. 8, which may transmit the set of LP-PRSs 820 using a first signal bandwidth, such as the bandwidth of the signal 914 in FIG. 9B or the bandwidth of the signal having the first part 922 and the second part 926 in FIG. 9C. 1508 may be performed by the neighbor network node 806 in FIG. 8, which may transmit the set of LP-PRSs 822 using a first signal bandwidth, such as the bandwidth of the signal 914 in FIG. 9B or the bandwidth of the signal having the first part 922 and the second part 926 in FIG. 9C. Moreover, 1508 may be performed by the component 197 FIG. 19 or 20.

At 1510, the first network node may transmit the set of LP-PRSs with a first power level. For example, 1510 may be performed by the serving network node 804 in FIG. 8, which may transmit the set of LP-PRSs 820 with a first power level for the signal 914 in FIG. 9B or for the signal having the first part 922 and the second part 926 in FIG. 9C. 1510 may be performed by the neighbor network node 806 in FIG. 8, which may transmit the set of LP-PRSs 822 with a first power level for the signal 914 in FIG. 9B or for the signal having the first part 922 and the second part 926 in FIG. 9C. Moreover, 1510 may be performed by the component 197 FIG. 19 or 20.

At 1512, the first network node may transmit the LP-WUS for the set of LP-PRSs 820 using a second signal bandwidth. The first signal bandwidth may be less than the second signal bandwidth. For example, 1512 may be performed by the serving network node 804 in FIG. 8, which may transmit the LP-WUS using a second signal bandwidth, such as the bandwidth of the signal 902 in FIG. 9A. The bandwidth of the signal 914 in FIG. 9B or the signal having the first part 922 and the second part 926 in FIG. 9C is less than the bandwidth of the signal 902 in FIG. 9A. 1512 may be performed by the neighbor network node 806 in FIG. 8, which may transmit the LP-WUS for the set of LP-PRSs 822 using a second signal bandwidth, such as the bandwidth of the signal 902 in FIG. 9A. The bandwidth of the signal 914 in FIG. 9B or the signal having the first part 922 and the second part 926 in FIG. 9C is less than the bandwidth of the signal 902 in FIG. 9A. Moreover, 1512 may be performed by the component 197 FIG. 19 or 20.

At 1514, the first network node may transmit the LP-WUS with a second power level. The first power level may be higher than the second power level. For example, 1514 may be performed by the serving network node 804 in FIG. 8, which may transmit the LP-WUS with a second power level for the signal 902 in FIG. 9A. The power level for the signal 902 in FIG. 9A may be less than the power level for the signal 914 in FIG. 9B or the signal having the first part 922 and the second part 926 in FIG. 9C. 1514 may be performed by the neighbor network node 806 in FIG. 8, which may transmit the LP-WUS with a second power level for the signal 902 in FIG. 9A. The power level for the signal 902 in FIG. 9A may be less than the power level for the signal 914 in FIG. 9B or the signal having the first part 922 and the second part 926 in FIG. 9C. Moreover, 1514 may be performed by the component 197 FIG. 19 or 20.

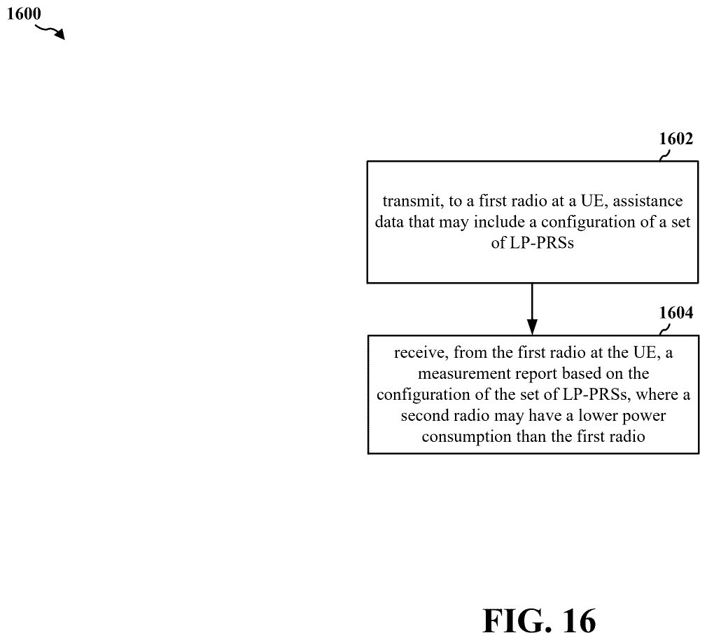

FIG. 16 is a flowchart 1600 of a method of wireless communication. The method may be performed by a second network node (e.g., the base station 102, the base station 310; the TRP 402, the TRP 406, the TRP 504, the TRP 505; the serving network node 704, the serving network node 804; the neighbor network node 706, the neighbor network node 806; the network entity 1802, the network entity 1902, the network entity 2060). At 1602, the second network node may transmit, to a first radio at a UE, assistance data that may include a configuration of a set of LP-PRSs. For example, 1602 may be performed by the LMF 808 in FIG. 8, which may transmit, to an HPR at the UE 802, the LPP 812 that may include assistance data including a configuration of a set of LP-PRSs, such as the LP-PRSs 820 and/or the LP-PRSs 822. 1602 may be performed by the serving network node 804 in FIG. 8, which may transmit, to an HPR at the UE 802, the posSIB 814 that may include assistance data including a configuration of a set of LP-PRSs, such as the LP-PRSs 820 and/or the LP-PRSs 822. Moreover, 1602 may be performed by the component 199 in FIG. 19 or 20.

At 1604, the first network node may receive, from the first radio at the UE, a measurement report based on the configuration of the set of LP-PRSs. A second radio at the UE may have a lower power consumption than the first radio at the UE. For example, 1604 may be performed by the LMF 808 in FIG. 8, which may receive an LCS event report 834 from the HPR of the UE 802. The LCS event report 834 may include a measurement report based on the configuration of the set of LP-PRSs, for example resources allocated to the LP-PRSs indicated by the configuration or a schedule of the LP-PRSs indicated by the configuration. 1604 may be performed by the serving network node 804 in FIG. 8, which may receive a UL-SDT 832 from the HPR of the UE 802. The UL-SDT 832 may include a measurement report based on the configuration of the set of LP-PRSs, for example resources allocated to the LP-PRSs indicated by the configuration or a schedule of the LP-PRSs indicated by the configuration. Moreover, 1604 may be performed by the component 199 in FIG. 19 or 20.

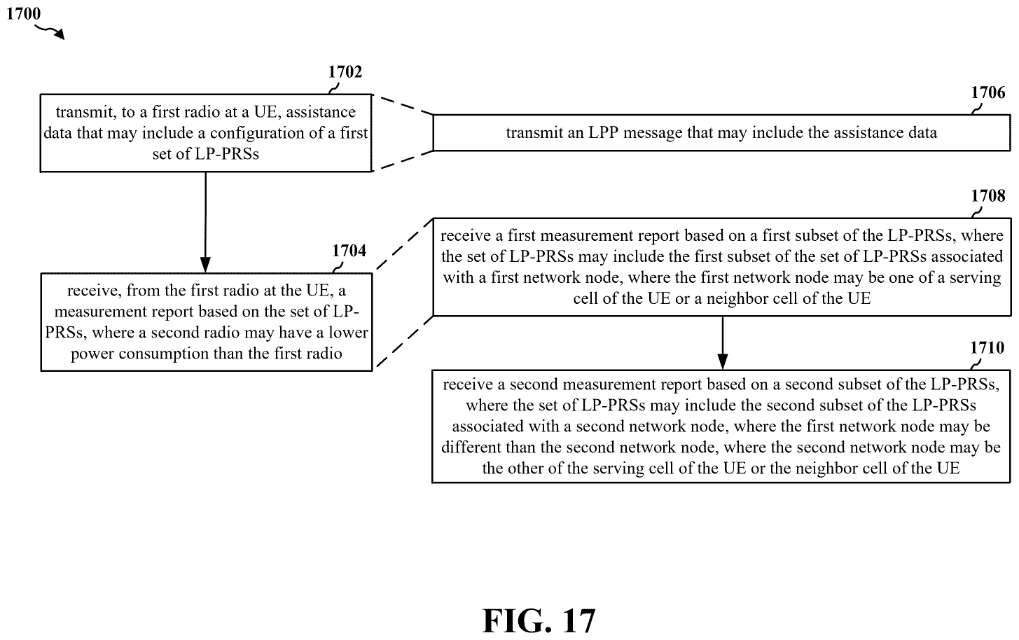

FIG. 17 is a flowchart 1700 of a method of wireless communication. The method may be performed by a second network node (e.g., the base station 102, the base station 310; the TRP 402, the TRP 406, the TRP 504, the TRP 505; the serving network node 704, the serving network node 804; the neighbor network node 706, the neighbor network node 806; the network entity 1802, the network entity 1902, the network entity 2060). At 1702, the second network node may transmit, to a first radio at a UE, assistance data that may include a configuration of a set of LP-PRSs. For example, 1702 may be performed by the LMF 808 in FIG. 8, which may transmit, to an HPR at the UE 802, the LPP 812 that may include assistance data including a configuration of a set of LP-PRSs, such as the LP-PRSs 820 and/or the LP-PRSs 822. 1702 may be performed by the serving network node 804 in FIG. 8, which may transmit, to an HPR at the UE 802, the posSIB 814 that may include assistance data including a configuration of a set of LP-PRSs, such as the LP-PRSs 820 and/or the LP-PRSs 822. Moreover, 1702 may be performed by the component 199 in FIG. 19 or 20.

At 1704, the first network node may receive, from the first radio at the UE, a measurement report based on the configuration of the set of LP-PRSs. The second radio may have a lower power consumption than the first radio at the UE. For example, 1704 may be performed by the LMF 808 in FIG. 8, which may receive an LCS event report 834 from the HPR of the UE 802. The LCS event report 834 may include a measurement report based on the configuration of the set of LP-PRSs, for example resources allocated to the LP-PRSs indicated by the configuration or a schedule of the LP-PRSs indicated by the configuration. 1704 may be performed by the serving network node 804 in FIG. 8, which may receive a UL-SDT 832 from the HPR of the UE 802. The UL-SDT 832 may include a measurement report based on the configuration of the set of LP-PRSs, for example resources allocated to the LP-PRSs indicated by the configuration or a schedule of the LP-PRSs indicated by the configuration. Moreover, 1704 may be performed by the component 199 in FIG. 19 or 20.

At 1706, the first network node may transmit an LPP message that may include the assistance data. For example, 1706 may be performed by the LMF 808 in FIG. 8, which may transmit an LPP message that may include the assistance data. 1706 may be performed by the serving network node 804 in FIG. 8, which may transmit the LPP 812 that may include the assistance data. Moreover, 1706 may be performed by the component 199 FIG. 19 or 20.

At 1708, the first network node may receive a first measurement report based on a first subset of the LP-PRSs. The set of LP-PRSs may include the first subset of the set of LP-PRSs associated with a first network node. The first network node may be one of a serving cell of the UE or a neighbor cell of the UE. For example, 1708 may be performed by the LMF 808 in FIG. 8, which may receive the LCS event report 834 including a measurement report based on the set of LP-PRSs 820 or the set of LP-PRSs 822. The set of LP-PRSs configured by the assistance data of the LPP 812 may include the set of LP-PRSs 820 associated with the serving network node 804. The set of LP-PRSs configured by the assistance data of the LPP 812 may include the set of LP-PRSs 822 associated with the neighbor network node 806. The serving network node 804 may be a serving cell of the UE 802. The neighbor network node 806 may be a neighbor cell of the UE 802. 1708 may be performed by the serving network node 804 in FIG. 8, which may receive the UL-SDT 832 that may include a measurement report based on the set of LP-PRSs 820 or the set of LP-PRSs 822. The set of LP-PRSs configured by the assistance data of the posSIB 814 may include the set of LP-PRSs 820 associated with the serving network node 804. The set of LP-PRSs configured by the assistance data of the posSIB 814 may include the set of LP-PRSs 822 associated with the neighbor network node 806. The serving network node 804 may be a serving cell of the UE 802. The neighbor network node 806 may be a neighbor cell of the UE 802. Moreover, 1708 may be performed by the component 199 FIG. 19 or 20.

At 1710, the first network node may receive a second measurement report based on a second subset of the LP-PRSs. The set of LP-PRSs may include the second subset of the LP-PRSs associated with a second network node. The first network node may be different than the second network node. The second network node may be the other of the serving cell of the UE or the neighbor cell of the UE. For example, 1710 may be performed by the LMF 808 in FIG. 8, which may receive an LCS event report 834 including a measurement report based on the set of the LP-PRSs 820 or the set of the LP-PRSs 822. The set of LP-PRSs configured by the assistance data of the LPP 812 may include the set of LP-PRSs 822 associated with the neighbor network node 806. The serving network node 804 may be a serving cell of the UE 802. The neighbor network node 806 may be a neighbor cell of the UE 802. The serving network node 804 is different than the neighbor network node 806. 1710 may be performed by the serving network node 804 in FIG. 8, which may receive the UL-SDT 832 that may include a measurement report based on the set of LP-PRSs 820 or the set of LP-PRSs 822. The set of LP-PRSs configured by the assistance data of the posSIB 814 may include the set of LP-PRSs 820 associated with the serving network node 804. The set of LP-PRSs configured by the assistance data of the posSIB 814 may include the set of LP-PRSs 822 associated with the neighbor network node 806. The serving network node 804 may be a serving cell of the UE 802. The neighbor network node 806 may be a neighbor cell of the UE 802. The serving network node 804 is different than the neighbor network node 806. Moreover, 1710 may be performed by the component 199 FIG. 19 or 20.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the Tx processor 368, the Rx processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see UE 350 of FIG. 3) and include the additional modules of the apparatus 1804.

As discussed supra, the component 198 is configured to receive, via a first radio, assistance data that may include a configuration of a set of LP-PRSs. The component 198 may receive, via a second radio, the set of LP-PRSs. The second radio may have a lower power consumption than the first radio. The component 198 may measure the set of LP-PRSs based on the configuration of the set of LP-PRSs. The component 198 may be within the cellular baseband processor 1824, the application processor 1806, or both the cellular baseband processor 1824 and the application processor 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, may include means for receiving, via a first radio, assistance data that may include a configuration of a set of LP-PRSs. The apparatus 1804 may include means for receiving, via a second radio, the set of LP-PRSs. The apparatus 1804 may include means for measuring the set of LP-PRSs based on the configuration of the set of LP-PRSs. The apparatus 1804 may include means for receiving, via the second radio, an LP-WUS that may include an indication associated with the set of LP-PRSs. The apparatus 1804 may include means for measuring the set of LP-PRSs based on the configuration of the set of LP-PRSs in response to receiving the LP-WUS. The apparatus 1804 may include means for reconfiguring an ADC of the second radio from a single bit operation to a multiple bit operation to receive or measure the set of LP-PRSs based on the LP-WUS. The apparatus 1804 may include means for receiving the set of PRSs by receiving the set of LP-PRSs using a first signal bandwidth. The apparatus 1804 may include means for receiving the LP-WUS by receiving the set of LP-WUS using a second signal bandwidth. The apparatus 1804 may include means for combining the non-continuous set of RB resources before measuring the combination of the non-continuous set of RB resources. The apparatus 1804 may include means for receiving the configuration of the set of LP-PRSs by receiving an LPP message or a posSIB that may include the assistance data. The apparatus 1804 may include means for calculating a position of the UE based on a first measurement of the set of LP-PRSs. The apparatus 1804 may include means for calculating an RSRP or an RSSI of at least one RS based on measuring the set of LP-PRSs. The apparatus 1804 may include means for transmitting a measurement report based on the calculated RSRP or RSSI. The apparatus 1804 may include means for receiving the set of LP-PRSs via the second radio by receiving a first subset of the set of LP-PRSs from a first network node via the second radio. The apparatus 1804 may include means for receiving the set of LP-PRSs via the second radio by receiving a second subset of the set of LP-PRSs from a second network node via the second radio. The means may be the component 198 of the apparatus 1804 configured to perform the functions recited by the means. As described supra, the apparatus 1804 may include the Tx processor 368, the Rx processor 356, and the controller/processor 359. As such, in one configuration, the means may be the Tx processor 368, the Rx processor 356, and/or the controller/processor 359 configured to perform the functions recited by the means.

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include a CU processor 1912. The CU processor 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include a DU processor 1932. The DU processor 1932 may include on-chip memory 1932′. In some aspects, the DU 1930 may further include additional memory modules 1934 and a communications interface 1938. The DU 1930 communicates with the RU 1940 through a fronthaul link. The RU 1940 may include an RU processor 1942. The RU processor 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 197 may be configured to transmit, to a second radio at a UE, a set of LP-PRSs. The component 197 may be configured to transmit, to the second radio at the UE, an LP-WUS that may include an indication to measure the set of LP-PRSs. The second radio may have a higher power consumption than a first radio at the UE. The component 197 may be within one or more processors of one or more of the CU 1910, DU 1930, and the RU 1940. The component 197 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 may include means for transmitting, to a second radio at a UE, a set of LP-PRSs. The network entity 1902 may include means for transmitting, to the second radio at the UE, an LP-WUS including a first indication to measure the set of LP-PRSs. The network entity 1902 may include means for transmitting the set of LP-PRSs by transmitting the set of LP-PRSs using a first signal bandwidth. The network entity 1902 may include means for transmitting the LP-WUS by transmitting the LP-WUS using a second signal bandwidth. The network entity 1902 may include means for transmitting the set of LP-PRSs by transmitting the set of LP-PRSs with a first power level. The network entity 1902 may include means for transmitting the LP-WUS may include transmitting the LP-WUS with a second power level. The network entity 1902 may include means for transmitting, to the first radio at the UE, assistance data that includes a configuration of the set of LP-PRSs. The network entity 1902 may include means for transmitting the assistance data by transmitting a posSIB that may include the assistance data. The network entity 1902 may include means for transmitting, to the first radio at the UE, assistance data that may include a configuration of the set of LP-PRSs. The means may be the component 197 of the network entity 1902 configured to perform the functions recited by the means. As described supra, the network entity 1902 may include the Tx processor 316, the Rx processor 370, and the controller/processor 375. As such, in one configuration, the means may be the Tx processor 316, the Rx processor 370, and/or the controller/processor 375 configured to perform the functions recited by the means.

As discussed supra, the component 199 is configured to transmit, to a first radio at a UE, assistance data that may include a configuration of a first set of LP-PRSs. The component 199 may receive, from the first radio at the UE, a measurement report based on the set of LP-PRSs from the UE. The first radio may have a higher power consumption than a second radio at the UE. The component 199 may be within one or more processors of one or more of the CU 1910, DU 1930, and the RU 1940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 may include means for transmitting, to a first radio at a UE, assistance data that may include a configuration of a first set of LP-PRSs. The network entity 1902 may include means for receiving, from the first radio at the UE, a measurement report based on the set of LP-PRSs. The first radio may have a higher power consumption than a second radio at the UE. The network entity 1902 may include means for transmitting the assistance data by transmitting an LPP message including the assistance data. The network entity 1902 may include means for receiving the measurement report based on the set of LP-PRSs by receiving a first measurement report based on the first subset of the LP-PRSs. The network entity 1902 may include means for receiving a second measurement report based on the second subset of the LP-PRSs. The means may be the component 199 of the network entity 1902 configured to perform the functions recited by the means. As described supra, the network entity 1902 may include the Tx processor 316, the Rx processor 370, and the controller/processor 375. As such, in one configuration, the means may be the Tx processor 316, the Rx processor 370, and/or the controller/processor 375 configured to perform the functions recited by the means.

FIG. 20 is a diagram 2000 illustrating an example of a hardware implementation for a network entity 2060. In one example, the network entity 2060 may be within the core network 120. The network entity 2060 may include a network processor 2012. The network processor 2012 may include on-chip memory 2012′. In some aspects, the network entity 2060 may further include additional memory modules 2014. The network entity 2060 communicates via the network interface 2080 directly (e.g., backhaul link) or indirectly (e.g., through a RIC) with the CU 2002. The on-chip memory 2012′ and the additional memory modules 2014 may each be considered a computer-readable medium/memory. Each computer-readable medium/memory may be non-transitory. The processor 2012 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 197 is configured to transmit, to a second radio at a UE, a set of LP-PRSs. The component 197 may be configured to transmit, to the second radio at the UE, an LP-WUS that may include an indication to measure the set of LP-PRSs. The second radio may have a higher power consumption than a first radio at the UE. The component 197 may be within the processor 2012. The component 197 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2060 may include a variety of components configured for various functions. In one configuration, the network entity 2060 includes means for transmitting, to a second radio at a UE, a set of LP-PRSs. The network entity 2060 may include means for transmitting, to the second radio at the UE, an LP-WUS including a first indication to measure the set of LP-PRSs. The network entity 2060 may include means for transmitting the set of LP-PRSs by transmitting the set of LP-PRSs using a first signal bandwidth. The network entity 2060 may include means for transmitting the LP-WUS by transmitting the LP-WUS using a second signal bandwidth. The network entity 2060 may include means for transmitting the set of LP-PRSs by transmitting the set of LP-PRSs with a first power level. The network entity 2060 may include means for transmitting the LP-WUS may include transmitting the LP-WUS with a second power level. The network entity 2060 may include means for transmitting, to the first radio at the UE, assistance data that includes a configuration of the set of LP-PRSs. The network entity 2060 may include means for transmitting the assistance data by transmitting a posSIB that may include the assistance data. The network entity 2060 may include means for transmitting, to the first radio at the UE, assistance data that may include a configuration of the set of LP-PRSs. The means may be the component 197 of the network entity 2060 configured to perform the functions recited by the means.

As discussed supra, the component 199 is configured to transmit, to a first radio at a UE, assistance data that may include a configuration of a first set of LP-PRSs. The component 199 may receive, from the first radio at the UE, a measurement report based on the set of LP-PRSs from the UE. The first radio may have a higher power consumption than a second radio at the UE. The component 199 may be within the processor 2012. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2060 may include a variety of components configured for various functions. In one configuration, the network entity 2060 includes means for transmitting, to a first radio at a UE, assistance data that may include a configuration of a first set of LP-PRSs. The network entity 2060 may include means for receiving, from the first radio at the UE, a measurement report based on the set of LP-PRSs. The first radio may have a higher power consumption than a second radio at the UE. The network entity 2060 may include means for transmitting the assistance data by transmitting an LPP message including the assistance data. The network entity 2060 may include means for receiving the measurement report based on the set of LP-PRSs by receiving a first measurement report based on the first subset of the LP-PRSs. The network entity 2060 may include means for receiving a second measurement report based on the second subset of the LP-PRSs. The means may be the component 199 of the network entity 2060 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include receiving, via a first radio, assistance data that may include a configuration of a set of LP-PRSs. The method may include receiving, via a second radio, the set of LP-PRSs. The second radio may have a lower power consumption than the first radio. The method may include measuring the set of LP-PRSs based on the configuration of the set of LP-PRSs.

Aspect 2 is the method of aspect 1, where the first radio may include an MR. The second radio may include an LP-WUR.

Aspect 3 is the method of either of aspects 1 or 2, where the method may include receiving, via the second radio, an LP-WUS that may include an indication associated with the set of LP-PRSs. Measuring the set of LP-PRSs based on the configuration of the set of LP-PRSs may be in response to receiving the LP-WUS.

Aspect 4 is the method of aspect 3, where the method may include reconfiguring an ADC of the second radio from a single bit operation to a multiple bit operation to receive or measure the set of LP-PRSs based on the LP-WUS.

Aspect 5 is the method of any of aspects 3 to 4, where receiving the set of PRSs may include receiving the set of LP-PRSs using a first signal bandwidth. Receiving the LP-WUS may include receiving the set of LP-WUS using a second signal bandwidth. The first signal bandwidth may be less than the second signal bandwidth.

Aspect 6 is the method of aspect 5, where the first signal bandwidth may have a first power level. The second signal bandwidth may have a second power level. The first power level may be higher than the second power level.

Aspect 7 is the method of any of aspects 1 to 6, where the set of LP-PRSs may include a continuous set of RB resources.

Aspect 8 is the method of any of aspects 1 to 7, where the set of LP-PRSs may include a non-continuous set of RB resources.

Aspect 9 is the method of aspect 8, where the method may include combining the non-continuous set of RB resources before measuring the combination of the non-continuous set of RB resources.

Aspect 10 is the method of any of aspects 1 to 9, where receiving the assistance data may include receiving an LPP message or a posSIB that may include the assistance data.

Aspect 11 is the method of aspect 10, where the LPP message may include a NAS message.

Aspect 12 is the method of any of aspects 1 to 11, where the set of LP-PRSs may be at least one of an OOK-based waveform or an amplitude-shift keying-based modulated waveform.

Aspect 13 is the method of any of aspects 1 to 12, where the method may include calculating a position of the UE based on a first measurement of the set of LP-PRSs. The method may include calculating an RSRP or an RSSI of at least one RS based on measuring the set of LP-PRSs. The method may include transmitting a measurement report based on the calculated RSRP or RSSI.

Aspect 14 is the method of any of aspects 1 to 13, where receiving the set of LP-PRSs via the second radio may include receiving a first subset of the set of LP-PRSs from a first network node via the second radio. Receiving the set of LP-PRSs via the second radio may include receiving a second subset of the set of LP-PRSs from a second network node via the second radio. The first network node may be different from the second network node. The first network node may be one of a serving cell of the UE or a neighbor cell of the UE. The second network node may be the other of the serving cell of the UE or the neighbor cell of the UE.

Aspect 15 is the method of any of aspects 1 to 14, where a first set of modulated symbols of the set of LP-PRSs may be mapped to a first set of sequential symbols. A second set of modulated symbols of the set of LP-PRSs may be mapped to a second set of sequential symbols. The second set of sequential symbols may be a repeat of the first set of sequential symbols.

Aspect 16 is the method of aspect 15, where the configuration of the set of LP-PRSs may include an offset between the first set of sequential symbols and the second set of sequential symbols.

Aspect 17 is the method of any of aspects 1 to 16, where a first set of modulated symbols of the set of LP-PRSs may be mapped to a first set of non-sequential symbols including a first symbol and a second symbol. A second set of modulated symbols of the set of LP-PRSs may be mapped to a second set of non-sequential symbols including a third symbol and a fourth symbol. The third symbol may be a first repeat of the first symbol. The fourth symbol may be a second repeat of the second symbol. The first symbol and the third symbol may be sequential. The second symbol and the fourth symbol may be sequential.

Aspect 18 is the method of any of aspects 1 to 17, where the assistance data may be received from an LMF. The set of LP-PRSs may be received from a serving base station.

Aspect 19 is the method of any of aspects 1 to 18, where the configuration of the set of LP-PRSs may include a duration of the set of LP-PRSs and a periodicity of the set of LP-PRSs. The duration of the set of LP-PRSs may be associated with the periodicity of the set of LP-PRSs.

Aspect 20 is the method of aspect 19, where the configuration of the set of LP-PRSs may include a second indication of a periodicity of the set of LP-PRSs. The periodicity of the set of LP-PRSs may meet or exceed a periodicity threshold.

Aspect 21 is the method of either of aspects 19 or 20, where the configuration may include a number of symbols associated with the duration of the set of LP-PRSs.

Aspect 22 is the method of any of aspects 19 to 21, where the configuration may include a cover code. Each of the set of LP-PRSs may include a set of segments. Each of the set of segments may include a binary addition of a short LP-PRS sequence and the cover code.

Aspect 23 is a method of wireless communication at a first network node, where the method may include transmitting, to a second radio at a UE, a set of LP-PRSs. The method may include transmitting, to the second radio at the UE, an LP-WUS including a first indication to measure the set of LP-PRSs. The second radio may have a lower power consumption than a first radio at the UE.

Aspect 24 is the method of aspect 23, where the first radio may include an MR. The second radio may include an LP-WUR.

Aspect 25 is the method of either of aspects 23 or 24, where the LP-WUS may further include a second indication to reconfigure at least one component at the UE to receive or measure the set of LP-PRSs based on the LP-WUS.

Aspect 26 is the method of any of aspects 23 to 25, where transmitting the set of LP-PRSs may include transmitting the set of LP-PRSs using a first signal bandwidth. Transmitting the LP-WUS may include transmitting the LP-WUS using a second signal bandwidth. The first signal bandwidth may be less than the second signal bandwidth. Transmitting the set of LP-PRSs may include transmitting the set of LP-PRSs with a first power level. Transmitting the LP-WUS may include transmitting the LP-WUS with a second power level. The first power level may be higher than the second power level.

Aspect 27 is the method of any of aspects 23 to 26, where the set of LP-PRSs may include a continuous set of RB resources.

Aspect 28 is the method of any of aspects 23 to 26, where the set of LP-PRSs may include a non-continuous set of RB resources.

Aspect 29 is the method of any of aspects 23 to 28, where the set of LP-PRSs may by at least one of OOK-based waveform or an amplitude-shift keying-based modulated waveform.

Aspect 30 is the method of any of aspects 23 to 29, where the method may include transmitting, to the first radio at the UE, assistance data that includes a configuration of the set of LP-PRSs. The second radio at the UE may be different than the first radio at the UE. The first radio may include an MR. The second radio may include an LP-WUR.

Aspect 31 is the method of aspect 30, where transmitting the assistance data may include transmitting a posSIB that may include the assistance data.

Aspect 32 is the method of either of aspects 30 or 31, where the configuration of the set of LP-PRSs may include a duration of the set of LP-PRSs and a periodicity of the set of LP-PRSs. The configuration may include a second indication of an association between the duration of the set of LP-PRSs and the periodicity of the set of LP-PRSs.

Aspect 33 is the method of aspect 32, where the configuration of the set of LP-PRSs may include a second indication of a periodicity of the set of LP-PRSs. The periodicity of the set of LP-PRSs may meet or exceed a periodicity threshold.

Aspect 34 is the method of either of aspects 32 or 33, where the configuration may include a number of symbols associated with the duration of the set of LP-PRSs.

Aspect 35 is the method of any of aspects 32 to 34, where the configuration may include a cover code. Each of the set of LP-PRSs may include a set of segments. Each of the set of segments may include a binary addition of a short LP-PRS sequence and the cover code.

Aspect 36 is the method of any of aspects 23 to 35, where the first network node may include at least one of a serving cell of the UE or a neighbor cell of the UE.

Aspect 37 is the method of any of aspects 23 to 36, where a first set of modulated symbols of the set of LP-PRSs may be mapped to a first set of sequential symbols. A second set of modulated symbols of the set of LP-PRSs may be mapped to a second set of sequential symbols. The second set of sequential symbols maybe a repeat of the first set of sequential symbols.

Aspect 38 is the method of aspect 37, where the set of LP-PRSs may include an offset between the first set of sequential symbols and the second set of sequential symbols.

Aspect 39 is the method of aspect 38, where the method may include transmitting, to the first radio at the UE, assistance data that may include a configuration of the set of LP-PRSs. The configuration may include the offset between the first set of sequential symbols and the second set of sequential symbols.

Aspect 40 is the method of any of aspects 23 to 39, where a first set of modulated symbols of the set of LP-PRSs may be mapped to a first set of non-sequential symbols including a first symbol and a second symbol. A second set of modulated symbols of the set of LP-PRSs may be mapped to a second set of non-sequential symbols including a third symbol and a fourth symbol. The third symbol may be a first repeat of the first symbol. The fourth symbol may be a second repeat of the second symbol. The first symbol and the third symbol may be sequential. The second symbol and the fourth symbol may be sequential.

Aspect 41 is the method of any of aspects 23 to 40, where the first network node may include at least one of a base station or a TRP.

Aspect 42 is a method of wireless communication at a second network node, where the method may include transmitting, to a first radio at a UE, assistance data that may include a configuration of a set of LP-PRSs. The method may include receiving, from the first radio at the UE, a measurement report based on the configuration of the set of LP-PRSs. The first radio may have a higher power consumption than a second radio at the UE.

Aspect 43 is the method of aspect 42, where the first radio at the UE may include an MR of the UE. The second radio at the UE may include an LPR of the UE.

Aspect 44 is the method of either of aspects 42 or 43, where transmitting the assistance data may include transmitting an LPP message including the assistance data.

Aspect 45 is the method of aspect 44, where the LPP message may include a NAS message.

Aspect 46 is the method of any of aspects 42 to 45, where the set of LP-PRSs may include a first subset of the set of LP-PRSs associated with a first network node. The set of LP-PRSs may include a second subset of the set of LP-PRSs associated with a second network node. The first network node may be different from the second network node. The first network node may be one of a serving cell of the UE or a neighbor cell of the UE. The second network node may be the other of the serving cell of the UE or the neighbor cell of the UE. Receiving the measurement report based on the set of LP-PRSs may include receiving a first measurement report based on the first subset of the LP-PRSs. The method may include receiving a second measurement report based on the second subset of the LP-PRSs.

Aspect 47 is the method of any of aspects 42 to 46, where the configuration of the set of LP-PRSs may include an offset between a first set of sequential symbols associated with the set of LP-PRSs and a second set of sequential symbols associated with the set of LP-PRSs.

Aspect 48 is the method of any of aspects 42 to 47, where the second network node may include an LMF.

Aspect 49 is the method of any of aspects 42 to 48, where the configuration of the set of LP-PRSs may include a duration of the set of LP-PRSs and a periodicity of the set of LP-PRSs. The duration of the set of LP-PRSs may be associated with the periodicity of the set of LP-PRSs.

Aspect 50 is the method of aspect 49, where the configuration of the set of LP-PRSs may include a second indication of a periodicity of the set of LP-PRSs. The periodicity of the set of LP-PRSs may meet or exceed a periodicity threshold.

Aspect 51 is the method of either of aspects 49 or 50, where the configuration may include a number of symbols associated with the duration of the set of LP-PRSs.

Aspect 52 is the method of any of aspects 49 to 52, where the configuration may include a cover code. Each of the set of LP-PRSs may include a set of segments. Each of the set of segments may include a binary addition of a short LP-PRS sequence and the cover code.

Aspect 53 is an apparatus for wireless communication, including: a memory; and at least one processor coupled to the memory and, based at least in part on information stored in the memory, the at least one processor is configured to implement any of aspects 1 to 52.

Aspect 54 is the apparatus of aspect 53, further including at least one of an antenna or a transceiver coupled to the at least one processor.

Aspect 55 is an apparatus for wireless communication including means for implementing any of aspects 1 to 52.

Aspect 56 is a computer-readable medium (e.g., a non-transitory computer-readable medium) storing computer executable code, where the code when executed by a processor causes the processor to implement any of aspects 1 to 52.

1. An apparatus for wireless communication at a user equipment (UE), comprising:
a memory; and
at least one processor coupled to the memory and, based at least in part on information stored in the memory, the at least one processor is configured to:
receive, via a first radio, assistance data comprising a configuration of a set of low-power (LP) positioning reference signals (LP-PRSs);
receive, via a second radio, the set of LP-PRSs, wherein the second radio has a lower power consumption than the first radio; and
measure the set of LP-PRSs based on the configuration of the set of LP-PRSs.

2. The apparatus of claim 1, wherein the first radio comprises a main radio (MR) and the second radio comprises an LP wake-up receiver (LP-WUR).

3. The apparatus of claim 1, wherein the at least one processor is further configured to:
receive, via the second radio, an LP wake-up signal (LP-WUS) comprising an indication associated with the set of LP-PRSs, wherein the at least one processor is configured to measure the set of LP-PRSs based on the configuration of the set of LP-PRSs in response to the at least one processor being configured to receive the LP-WUS.

4. The apparatus of claim 3, wherein the at least one processor is further configured to:
reconfigure an analog-to-digital converter (ADC) of the second radio from a single bit operation to a multiple bit operation to be configured to receive or measure the set of LP-PRSs based on the LP-WUS.

5. The apparatus of claim 3, wherein, to receive the set of LP-PRSs, the at least one processor is configured to receive the set of LP-PRSs using a first signal bandwidth, wherein, to receive the LP-WUS, the at least one processor is configured to receive the LP-WUS using a second signal bandwidth, wherein the first signal bandwidth is less than the second signal bandwidth.

6. The apparatus of claim 5, wherein the first signal bandwidth has a first power level, wherein the second signal bandwidth has a second power level, wherein the first power level is higher than the second power level.

7. The apparatus of claim 1, wherein the set of LP-PRSs comprises a non-continuous set of resource block (RB) resources.

8. The apparatus of claim 7, wherein the at least one processor is further configured to:
combine the non-continuous set of RB resources before the at least one processor is configured measure the combination of the non-continuous set of RB resources.

9. The apparatus of claim 1, further comprising a transceiver coupled to the at least one processor, wherein, to receive the assistance data, the at least one processor is configured to:
receive, via the transceiver, at least one of a long-term evolution (LTE) positioning protocol (LPP) message or a positioning system information block (posSIB) comprising the assistance data.

10. The apparatus of claim 1, wherein the set of LP-PRSs is at least one of an on-off keying (OOK)-based waveform or an amplitude-shift keying-based modulated waveform.

11. The apparatus of claim 1, wherein the at least one processor is further configured to:
calculate a reference signal received power (RSRP) or a reference signal strength indicator (RSSI) of at least one reference signal (RS) based on the at least one processor being configured to measure the set of LP-PRSs; and
transmit a measurement report based on the RSRP or the RSSI of the at least one RS.

12. The apparatus of claim 1, wherein, to receive the set of LP-PRSs via the second radio, the at least one processor is configured to:
receive a first subset of the set of LP-PRSs from a first network node via the second radio; and
receive a second subset of the set of LP-PRSs from a second network node via the second radio, wherein the first network node is different from the second network node.

13. The apparatus of claim 1, wherein a first set of modulated symbols of the set of LP-PRSs is configured to be mapped to a first set of sequential symbols, wherein a second set of modulated symbols of the set of LP-PRSs is configured to be mapped to a second set of sequential symbols, wherein the second set of sequential symbols is a repeat of the first set of sequential symbols.

14. The apparatus of claim 13, wherein the configuration of the set of LP-PRSs comprises an offset between the first set of sequential symbols and the second set of sequential symbols.

15. The apparatus of claim 1, wherein a first set of modulated symbols of the set of LP-PRSs is configured to be mapped to a first set of non-sequential symbols comprising a first symbol and a second symbol, wherein a second set of modulated symbols of the set of LP-PRSs is configured to be mapped to a second set of non-sequential symbols comprising a third symbol and a fourth symbol, wherein the third symbol is a first repeat of the first symbol, wherein the fourth symbol is a second repeat of the second symbol, wherein the first symbol and the third symbol are sequential, wherein the second symbol and the fourth symbol are sequential.

16. The apparatus of claim 1, wherein the configuration of the set of LP-PRSs comprises a duration of the set of LP-PRSs and a periodicity of the set of LP-PRSs, wherein the duration of the set of LP-PRSs is associated with the periodicity of the set of LP-PRSs.

17. The apparatus of claim 16, wherein the configuration of the set of LP-PRSs comprises a cover code, wherein each of the set of LP-PRSs comprises a set of segments, wherein each of the set of segments comprises a binary addition of a short LP-PRS sequence and the cover code.

18. An apparatus for wireless communication at a first network node, comprising:
a memory; and
at least one processor coupled to the memory and, based at least in part on information stored in the memory, the at least one processor is configured to:
transmit, to a second radio at a user equipment (UE), a set of low-power (LP) positioning reference signals (LP-PRSs); and
transmit, to the second radio at the UE, an LP wake-up signal (LP-WUS) comprising an indication to measure the set of LP-PRSs.

19. The apparatus of claim 18, wherein the LP-WUS further comprises a second indication configured to reconfigure at least one component at the UE to be configured to receive or measure the set of LP-PRSs based on the LP-WUS.

20-28. (canceled)

29. A method of wireless communication at a user equipment (UE), comprising:
receiving, via a first radio, assistance data comprising a configuration of a set of low-power (LP) positioning reference signals (LP-PRSs);
receiving, via a second radio, the set of LP-PRSs, wherein the second radio has a lower power consumption than the first radio; and
measuring the set of LP-PRSs based on the configuration of the set of LP-PRSs.

30. (canceled)
